(19) United States
(12) Patent Application Publication
(10) Pub. No.: US 2007/0268206 A1
(43) Pub. Date: Nov. 22, 2007

(54) Image display device

(75) Inventors: Masayoshi Kinoshita, Hachioji (JP); Hiroshi Kageyama, Hachioji (JP); Hajime Akimoto, Kokubunji (JP)

Correspondence Address: Stanley P. Fisher;Reed Smith LLP, Suite 1400, 3110 Fairview Park Drive, Falls Church, VA, 22042-4503, US

(73) Assignee: Hitachi Diplays, Ltd.

(21) Appl. No.: 11/798,752

(22) Filed: May 16, 2007

(30) Foreign Application Priority Data
May 18, 2006 (JP) 2006-138689

(51) Int. Cl. G09G 3/00

(52) U.S. Cl. 345/30

(57) ABSTRACT

The present invention provides an image display device which includes a photo-sensing circuit capable of high-speed light signal reading at high S/N ratio and has a touch-panel function with less influence by disturbance light and less wrong recognition.

The image display device comprises a display unit in which display pixels having thin-film transistors are arranged in a matrix and a plurality of light detection pixels within the display unit. The image display device is configured in such a way that a first light sensing element that receives observation light and a second light sensing element that does not receive observation light are electrically connected, and that a blue color filter and the first light detection pixel are overlapped and a green or a red color filter and the second light detection pixel are overlapped at a light sensing element that outputs potential modulation at the connection point of the first and second light sensing elements.

### CLAIM OF PRIORITY

The present application claims priority from Japanese application JP 2006-138689 filed on May 18, 2006, the content of which is hereby incorporated by reference into this application.

### BACKGROUND OF THE INVENTION

1. Field of the Invention

The present invention relates to an image display device which incorporates an input function that enables inputting of light signal with high S/N ratio.

2. Description of the Related Art

In recent years, image display devices using liquid crystal have been employed popularly as display screens for appliances such as personal computers, mobile phones and PDAs since they have significant advantages of low-profile design, light in weight and low power consumption. Further, the applications are expanded by providing screen input functions such as touch-panel inputting and pen-based inputting, and development of technologies for screen input functions are becoming active. However, incorporation of screen input functions results in addition of parts and components for this purpose, which will end up with increased costs. Furthermore, conventionally, a display unit and a touch panel were independently developed and designed before they were brought into an assembly manufacturer. Therefore, there were problems of decreased yield or deterioration in mechanical strength caused by integration work of the display and the touch panel.

Conventionally, a drive circuit to drive a switching element arranged for each pixel was configured as an external part to be added on a transparent substrate on which switching elements are integrated. Recently, however, a technique that enables the drive circuit to be mounted on the transparent substrate has been developed. By taking the similar method, by mounting parts necessary for the screen inputting function on a transparent substrate, it becomes possible to reduce the total cost and further realize slimmer screen bezel of a display terminal unit slimmer or thinner-profile design of the unit.

Hereinafter, conventional art will be described with reference to FIG. 26.

First, structure of a conventional art example 1 will be described. FIG. 26 shows a circuit configuration of a liquid crystal image display device according to the conventional art example 1 which is capable of inputting a light signal. Each pixel arranged on a display unit 210 is configured with a display pixel TFT (Thin Film Transistor) 202 and a liquid crystal capacitor 201. The gate of the display pixel TFT 202 is connected to a gate-line scan circuit 212, an end of the source-drain path of the display pixel TFT 202 is connected to the liquid crystal capacitor 201, and the other end to a signal output circuit 211.

Further, on a display 210, a photo-sensing TFT 203 which is formed by TFT having a top gate and a bottom gate is arranged. An end of the photo-sensing TFT 203 is grounded, the bottom gate is connected to a bottom gate scan circuit 214, the top gate is connected to a top gate scan circuit 215, and the other end of the photo-sensing TFT 203 is connected to a pre-charging circuit 216 and a light signal sensor circuit 213, respectively. Furthermore, the signal output circuit 211, gate-line scan circuit 212, the light signal sensor circuit 213, the bottom gate scan circuit 214 and the top gate scan circuit 215 are controlled by a control circuit 217.

Next, operations of the conventional art 1 will be described.

As the prescribed display pixel TFT 202 selected by the gate-line scan circuit 212 is turned on, a display signal which is output from the signal output circuit 211 is written in the liquid crystal capacitor 201 for the prescribed pixel via the selected display pixel TFT 202, whereby enabling display of an image on the display unit 210. Further, when a light signal output of the photo-sensing TFT 203 that is selected by the bottom gate scan circuit 214 and the top gate scan circuit 215 is read out to a wiring line which is pre-charged by the pre-charging circuit 216, the light signal is read out by the light signal sensor circuit 213, whereby enabling detection of a write light signal pattern that is input to the display unit 210.

According to the conventional art 1, in addition to displaying an image on the display unit 210, it is also possible to detect a two-dimensional optical signal pattern by using the display unit 210. A typical example of such arrangement is described in detail in JP-A-2000-259346.

A generally-known display device including an image scanning function is arranged in such a manner that a light sensor is formed on a glass substrate on which a TFT for liquid crystal drive is formed and the TFT is placed between the liquid crystal element and the backlight. When such configuration is employed, the backlight will illuminate the light sensor on the glass substrate, and light that is illuminated by the backlight will be the direct light incident on the light sensor, in addition to the light that is reflected on the detection object placed on the screen. The light which is the direct light incident on the light sensor from the backlight will make the light sensor to generate electric current irrespective of the light reflected on the detection object, and the light will be a factor to deteriorate the S/N ratio which indicates sensitivity for detecting light intensity reflected by the detection object.

Further, for the conventional art 2, in an image display device which incorporates a light sensor to avoid deterioration of the S/N ratio described above, a configuration wherein a glass substrate is arranged in a manner that the surface of the substrate faces the backlight is known. With such arrangement, the light reflected on a finger that touched the screen will reach the light sensor just by passing through a deflector plate and a glass substrate, which eliminates deterioration in light intensity reflected by the detection object, thus ensuring improved S/N ratio of the light sensor. A typical example of such arrangement is described in JP-A-2004-140338.

### SUMMARY OF THE INVENTION

With the conventional art 1, although it is configured to satisfy the requirements for image inputting and image displaying, the problem that it is difficult to improve S/N ratio of the light sensor still remains. Enlargement of the light sensor size for higher sensitivity may cause a problem that the sensing area is expanded, resulting in deteriorated rate of opening area of a display pixel.

In the case of a liquid crystal display device, in particular, influence of backlight is strong, and, in some cases, backlight intensity several ten times or more that of the light incident on the display unit is applied to the light sensor element. In addition, besides other factors such as strong disturbance light such as sunlight and illumination light that are incoming through the screen, electrons that are generated according to light intensity in the photodiode of the light sensor, dark current that thermally generates electrons/hole pairs may give significant influences.

As a result, S/N ratio of optical signal output that is read out from the light sensor becomes very small, which made high-sensitivity, high-speed reading difficult in the past. Accordingly, the problem causes poor detection accuracy, incorrect recognition, etc. of the light sensor.

Enlargement of the light sensor size for higher sensitivity expands the sensing area to shield light at the backlight side, which virtually deteriorates the rate of opening area of display pixel. To obtain equivalent picture quality, therefore, brightness of the backlight must be increased, which, in turn, results in increased power consumption of the device, thus leading to deteriorated service life of the backlight. In addition, miniaturization or higher resolution quality becomes difficult to be achieved.

With the conventional art 2, for example, decrease in light intensity of light reflected by the detection object is small, which improves S/N ratio of the light sensor. However, when disturbance lights such as sunlight or illumination light is irradiated from the front (screen) side of the image display device, the disturbance light is reflected on the TFT or metal wiring lines that are formed on a glass substrate and are sandwiched by two glass substrates, and such reflected light may appear on the screen to exercise an influence on deterioration of picture quality such as visibility. Therefore, it is difficult to satisfy both of image inputting and image displaying.

An example of typical measures of those inventions that are disclosed in the specification is described as follows. That is, an image display device according to the present invention is characterized in that the image display device comprises:

a display unit in which a plurality of display pixels are arranged in a matrix; a plurality of display signal lines which write display signals in the display pixels; a light detection unit which has a plurality of light detection pixels arranged in the display unit for detecting light inputs; a signal reading unit which executes prescribed signal processing upon receiving the detection signals from the light detection unit; and a light detection pixel selection means for reading processed signals that are processed in the signal reading unit, wherein

a plurality of light detection pixels of the light detection unit includes a first light detection element that receives observation light and a second light detection element that does not receive observation light, and the signal reading unit, upon receiving a first detection signal which is generated by the first light detection element and a second detection signal which is generated from the second light detection element, executes the prescribed signal processing, and the processed signal that is processed earlier is output from the plurality of light detection pixels that are selected by the light detection pixel selection means.

According to the present invention, high-speed reading of a light signal is possible at high S/N ratio, irrespective of luminance of backlight or noise of dark current, and an image display device which incorporates a touch-panel function featuring less wrong recognition can be realized.

### BRIEF DESCRIPTION OF THE DRAWINGS

FIG. 1 shows an exploded perspective view of the structure of an image display device according to the present invention.

FIG. 2 shows a cross-section structure of a photo-sensing circuit of the first embodiment.

FIGS. 3A and 3B show a diagram illustrating dependency of light intensity of light to be illuminated on a TFT and drain current.

FIG. 4 shows a circuit diagram of a photo-sensing circuit PS that is used for the first embodiment.

FIG. 5 shows a diagram illustrating relationship of electric current and potential at terminal A of the photo-sensing circuit PS when light intensity of the backlight has varied under the condition that no light is illuminated from the screen side of the image display device of the first embodiment.

FIG. 6 shows a diagram illustrating relationship between electric current and potential at the terminal A of the photo-sensing circuit PS when light is illuminated from the screen side of the image display device of the first embodiment.

FIG. 7 shows a circuit diagram of the photo-sensing circuit SEN of the first embodiment.

FIG. 8 shows a timing chart illustrating voltage waveforms of the photo-sensing circuit.

FIG. 9 shows a circuit configuration of the image display device of the first embodiment.

FIG. 10 shows voltage waveforms which drive the display pixel circuit.

FIGS. 11A to 11D show detection operations of the photo-sensing circuit SEN of the first embodiment.

FIG. 12 shows a layout example of the first embodiment.

FIG. 13 shows a configuration of the sensor circuit of the first embodiment.

FIG. 14 shows wavelength dependency of light transmittance of a general color filter.

FIG. 15 shows a cross-section structure of a light sensor unit SEN of the second embodiment.

FIGS. 16A and 16B show dependency of light intensity of the light that is illuminated on the TFT and drain current.

FIG. 17 shows a circuit diagram of the photo-sensing circuit SEN of the second embodiment.

FIG. 18 shows a circuit configuration diagram of the image display device of the second embodiment.

FIG. 19 shows a layout example of the second embodiment.

FIG. 20 shows the status that a prescribed image is displayed on the display unit.

FIG. 21 shows a mobile electronic apparatus to which the image display device according to the present invention is applied.

FIG. 22 shows a layout example of the display pixel circuit and the photo-sensing circuit of the third embodiment.

FIG. 23 shows a cross-section structure of the image display device according to the third embodiment.

FIG. 24 shows a circuit configuration diagram of a photo-sensing circuit PS of the fourth embodiment.

FIG. 25 shows a cross-section structure of an image display device of the fourth embodiment.

FIG. 26 shows a circuit configuration of a liquid crystal image display device according to the conventional art 1 which is capable of inputting a light signal.

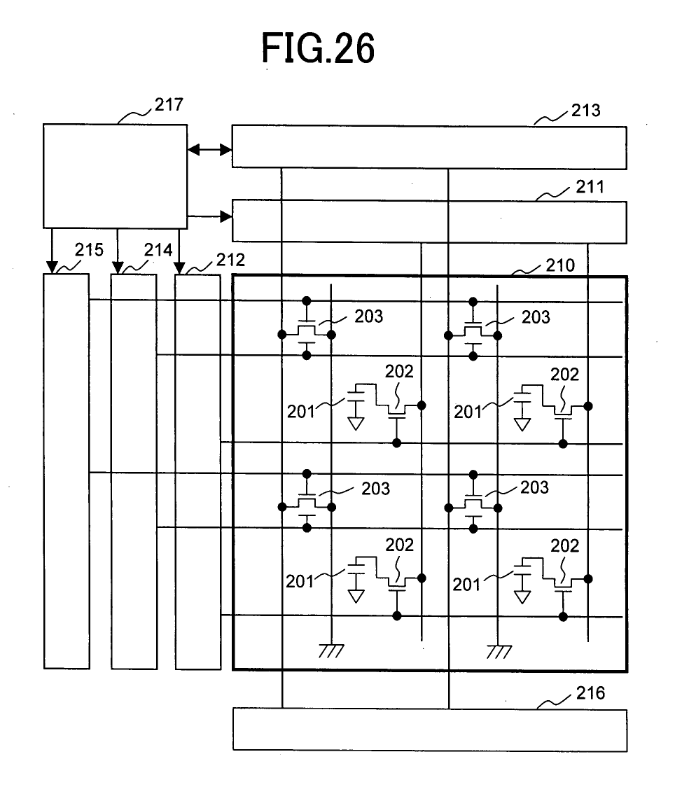

DESCRIPTION OF REFERENCE NUMERALS

| | |
|---|---|
| 1 | Display pixel TFT |
| 2 | Liquid crystal capacitor |
| 3 | Photo-sensing TFT 3 |
| 4 | Photo-sensing TFT 4 |
| 5 | Read TFT |
| 6 | Capacitor |
| 7 | Inverter amplifier |
| 8 | Reset TFT |
| 9 | Storage capascitor |
| 10 | Output signal line |
| 11 | Data driver circuit |
| 12 | Scan circuit |
| 13 | Sensor circuit |
| 14 | Sensor gate line selection circuit |
| 16 | Display area |
| 17 | Film substrate |
| 18 | Metal wiring |
| 19 | Connection terminal |
| 20 | Counter defector plate |
| 21 | Color filter side glass substrate |
| 22 | Counter electrode |
| 23 | Color filter |
| 24 | Black matrix |
| 25 | Liquid crystal element |
| 26 | TFT substrate |
| 27 | Glass substrate |
| 28 | Lower defector plate |
| 29 | Backlight |
| 40 | Insulation film |
| 41 | Polysilicon layer |
| 42 | Gate insulation film |
| 43 | Gate metal layer |
| 44 | Interlayer insulation film |
| 45 | Metal wiring layer |
| 46 | Contact hole |
| 47 | Planarizing insulation film |
| 48 | Display electrode |
| 49 | Channel layer |
| 50 | Opening |
| 51 | Finger |
| 71 | Sample hold circuit |
| 72 | Amplifier |
| 73 | Latch circuit |
| 74 | Selection switch |
| 75 | Selection switch |
| 81 | Contact hole |
| 91 | Red color filter |
| 92 | Green color filter |
| 93 | Blue color filter |
| 151 | Image display device |
| 152 | Mobile electronic apparatus |
| 153 | Arrow key |

### DETAILED DESCRIPTION OF THE PREFERRED EMBODIMENTS

Hereinafter, suitable preferred embodiments of the image display device according to the present invention will be described in detail with reference to the accompanying drawings.

### First Embodiment

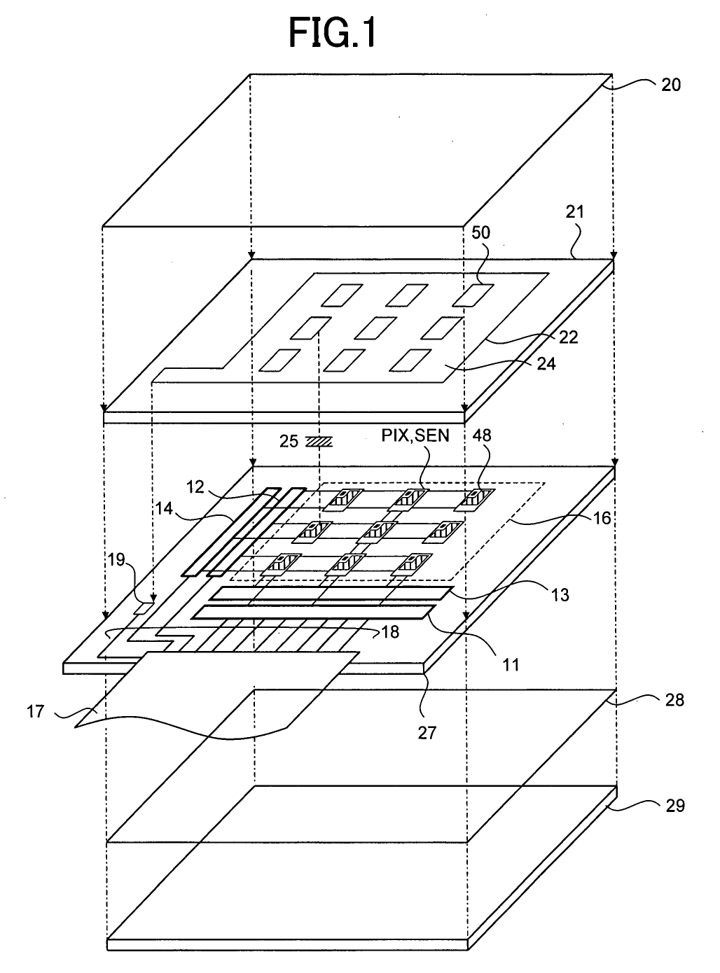

Hereinafter, concerning a first embodiment of the present invention, the configuration and operations thereof will be described in sequence with reference to FIGS. 1 to 13.

FIG. 1 shows an exploded perspective view of the structure of an image display device according to the present invention. On the surface of a glass substrate 27, a signal output circuit 11, a gate line scan circuit 12, a sensor circuit 13 and a sensor gate line selection circuit 14 that are formed by using TFTs are arranged. In a display area 16, a display pixel circuit PIX and a photo-sensing circuit SEN, which are manufactured in a TFT manufacturing process, are arranged and formed in a matrix. On the glass substrate 27, a film substrate 17 (FPC: Flexible Printed Circuit) is affixed, and a voltage signal from an external source and voltage that is required for driving the circuit are fed via the film substrate 17.

Wiring lines 18 which connect the film substrate 17, the signal output circuit 11, the gate line scan circuit 12, the sensor circuit 13, the sensor gate line selection circuit 14 and the display area 16 are formed by utilizing a metal wiring layer that is used in the TFT forming process. A display electrode 48 is formed in a manner to overlap respective display pixel circuits PIX and photo-sensing circuits SEN.

The glass substrate 27 is laminated with another color filter side glass substrate 21 with a liquid crystal having thickness of several μm (not shown in the figure) sandwiched in between the two substrates. Thickness of the liquid crystal can be maintained to be constant by dispersing spherical spacers (not shown in the figure) on the glass substrate 27. On the under-side surface of the color-filter side glass substrate 21, a counter electrode 22 is formed, and, a liquid crystal element 25 is formed by sandwiching the liquid crystal with the counter electrode 22 and the display electrodes 48 of respective display pixel circuits PIX. Here, it should be noted that, in FIG. 1, the liquid crystal element 25 is typically exemplified with a pair of display pixel 48 and a counter electrode 22. Actually, however, the liquid crystal 25 is formed for all display pixels 48 and the counter electrodes 22.

By connecting the counter electrode 22 to a connection terminal 19 that is provided outside the display area 16 on the glass substrate 27, a counter electrode voltage is supplied via the film substrate 17. An opening 50 is provided at a position that overlaps with the display electrode 48 when the inner surface of the color filter side glass substrate 21 is laminated to the other substrate. In areas other than the opening 50, a black matrix 24 is applied to prevent transmission of light in the areas other than the opening 50. In addition, at the opening 50, color filters (not shown in the figure) in red, green and blue (RGB) are provided, whereby enabling color display.

On the under-side of the glass substrate 27, a deflector plate 28 (lower deflector plate) is affixed, and on the surface of the color filter side glass substrate 22, opposite to the glass substrate 27, a counter deflector plate 20 (upper deflector plate) is affixed. Further, fluorescent white light that is obtained by converting backlight 29 comprising a fluorescent lamp (not shown in the figure) and a light guide plate (not shown in the figure) into an even surface light source by using the light guide plate is illuminated from under side of the glass substrate 27.

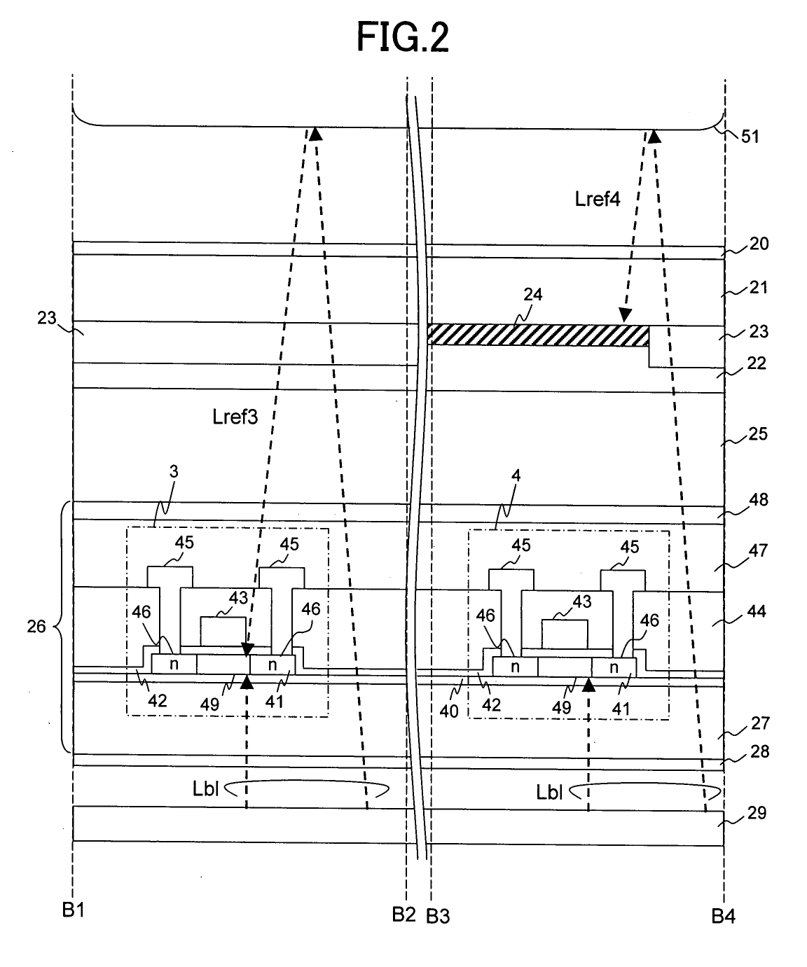

FIG. 2 shows a cross-section structure of the photo-sensing circuit SEN which is used for the image display device of the first embodiment.

The image display device of the first embodiment includes the counter deflector plate 20, the color filter side glass substrate 21, a color filter 23, the black matrix 24, the counter electrode 22, the liquid crystal element 25, the glass substrate 27, the lower deflector plate 28 and the backlight 29. The figure shows the status that the screen of the image display device is touched with a finger 51.

The photo-sensing circuit SEN is configured by combination of a first photo-sensing TFT 3 and a second photo-sensing TFT 4 that are formed on the glass substrate 27. The first photo-sensing TFT 3 is arranged beneath the color filter 23 and light after passing through the color filter 23 is incident on the photo-sensing TFT 3. Therefore, the first photo-sensing TFT 3, as it is exposed to sunlight striking the screen, illumination in a room or light reflected by a finger used to touch the screen, outputs electric current according to light intensity of the incident light.

On the other hand, the second photo-sensing TFT 4 is arranged beneath the black matrix 24. Since light sunlight striking the screen, illumination in a room or light reflected by a finger used to touch the screen that is incident to the photo-sensing circuit SEN from the screen surface is shielded by the black matrix 24, light coming from the top side is not incident on the second photo-sensing TFT 4, and only the light from the backlight which is incident from the bottom side of the second light detector TFT 4 is incident on the TFT 4, which will be described later.

An n-type channel layer 49 of the photo-sensing TFT 3 and the photo-sensing TFT 4 is formed through processes wherein an insulation film 40 made of oxide silicon is formed on the glass substrate 27, a polysilicon layer 41 is further formed on the insulation film 40, and n-type impurities are doped on the polysilicon layer 41. A gate metal layer 43 is formed on the channel layer 49 with a gate insulation film 42 made of oxide silicon sandwiched in between the layers 43 and 49. Further, on the gate metal layer 43, a metal wiring layer 45 is formed with an inter-layer insulation film 44 made of oxide silicon sandwiched in between the layer 43 and the layer 45, wherein the metal wiring layer 45 penetrates through the gate insulation film 42 and the inter-layer insulation film 44 with a contact hole 46 and is connected to the polysilicon layer 41 doped in n-type impurities, thus forming an electrode. Furthermore, the display electrode 48 is formed on the metal layer 45 with a planarizing insulation film 47 sandwiched in between the metal layer 45 and the display electrode 48.

White light Lb1 that is illuminated by the backlight 29, after penetrating the lower deflector plate 28 and the glass substrate 27, illuminates the lower side of the channel layer 49 of the photo-sensing TFT 3 and the photo-sensing TFT 4.

On the other hand, the light Lb1 of the back light 29 penetrates the lower deflector plate 28, the glass substrate 27, a TFT substrate 26, the liquid crystal element 25, the counter electrode 22, the color filter 23, the color filter side glass substrate 21, and the color filter side deflector plate 20. While touch-reflected light Lref that is reflected by the finger 51 touching the screen is reflected again toward the TFT substrate 26. The light Lb1 and Lref then pass through the color filter side deflector plate 20, the color filter side glass substrate 21, the color filter 23, the counter electrode 22 and the liquid crystal element 25 and are incident on the TFT substrate 26.

Light Lref 3 which is reflected toward the photo-sensing TFT 3 is repeatedly reflected between the gate electrode 43 of the photo-sensing TFT 3 and the gate insulation film 42 and is incident on the channel layer 49. Since light Lref 4 that is reflected toward the photo-sensing TFT 4 is shielded by the black matrix 24 that is arranged to cover the photo-sensing TFT 4, it will not be incident on the channel layer 49 of the photo-sensing TFT 4. Therefore, the light to be illuminated on the photo-sensing TFT 3 is limited to the backlight Lb 1 which is incident from the lower side of the light detector TFT 3 and the touch-reflected light Lref 3 which is incident from the upper side of the photo-sensing TFT 3. On the other hand, light to be illuminated on the photo-sensing TFT 4 is limited only to the backlight Lb 1 which is incident from the lower side of the photo-sensing TFT 4.

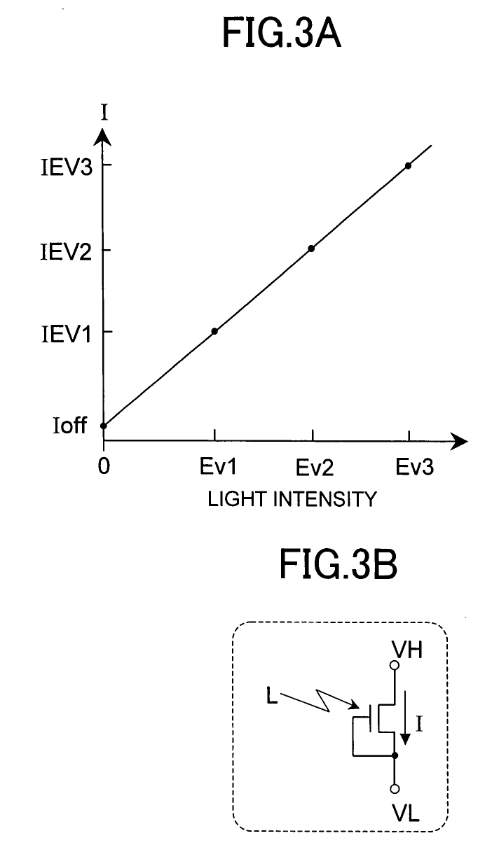

FIG. 3A shows dependency of drain current on light intensity when light is illuminated on a TFT. The horizontal axis shows light intensity Ev of light L which illuminates the TFT and the vertical axis shows drain current I of the TFT. As shown in FIG. 3B, applying high potential VH to the drain of TFT and low potential VL to the source and configuring a diode connection of the gate and the source generates drain current Ioff that derives from dark current. Further, due to light energy generated when illuminating the light L, electrons in the TFT channel is directly energized to a conducting band from a valence band, which generates drain current I that is dependent on the light intensity L. At this time, the drain current I is assumed to be zero (0) when no light is illuminated on the TFT, and the drain current I increases to Ioff, IEV, IEV2 and IEV3 in proportion to light intensity of the light L as light intensity of the light L to be illuminated on the TFT increases to EV1, EV2 and EV3.

For the image display device according to the first embodiment, by utilizing the characteristic that electric current that is dependent on light intensity is generated in TFT, the photo-sensing circuit SEN which enables the TFT to function as a light sensor is manufactured on the glass substrate 27. By doing this, inputting functions including touch-panel function can be materialized.

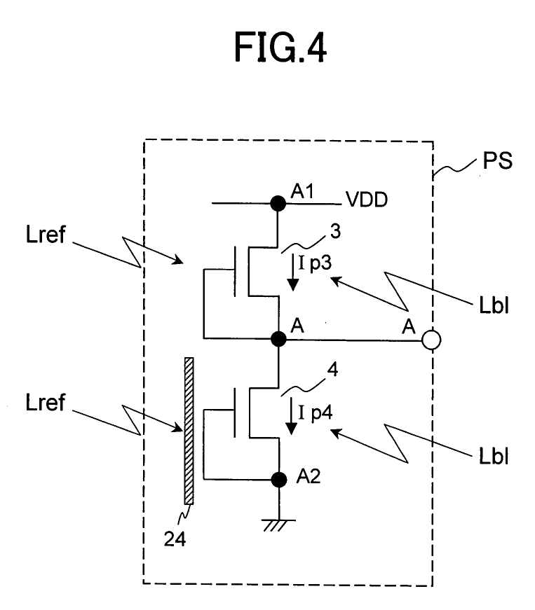

FIG. 4 shows a circuit diagram of a photo-sensing circuit PS that is used for the present embodiment. An end of the drain-source path of the photo-sensing TFT 3 and the power supply VDD are connected at node A1, and the gate and the other end of the drain-source path of the photo-sensing TFT 3 are diode-connected at node A. An end of the drain-source path of the photo-sensing TFT 4 is connected to the connection node A, the gate and the other drain-source path of the photo-sensing TFT 4 are diode-connected at node A2 and the node A2 is grounded (GND).

Light sources concerning the present embodiment include touch-reflected light Lref which is illuminated from the screen direction of the image display device toward the photo-sensing TFT 3 and the photo-sensing TFT 4 of the photo-sensing circuit PS, and backlight Lb1 which is illuminated from the backlight 29 and then from the lower side of the photo-sensing TFT 3 and the photo-sensing TFT 4 via the glass substrate 27.

On the photo-sensing TFT 3, the backlight Lb1 and the touch-reflected light Lref are illuminated. Although the backlight light Lb1 is illuminated on the photo-sensing TFT 4, since the touch-reflected light Lref is shielded by the black matrix 24 that is arranged on the photo-sensing TFT 4, it is not illuminated on the photo-sensing TFT 4.

As described in the above, when light is illuminated on the photo-sensing TFT 3 and the photo-sensing TFT 4, photo-electric current which is dependent on light intensity of the light flows in the photo-sensing TFT 3 as electric current Ip 3, and, in the photo-sensing TFT 4 as electric current Ip4. As a result, voltage at the node A, depending on current value of the current Ip3 and Ip4, varies between GND level and VDD level.

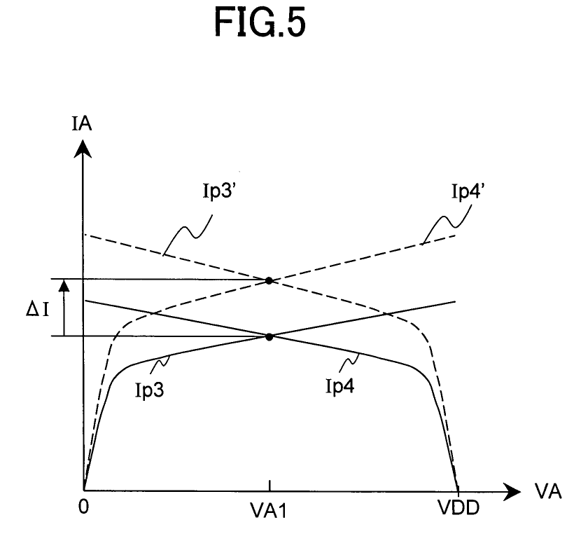

FIG. 5 is a diagram illustrating the relationship of electric current IA and potential VA at terminal A of the photo-sensing circuit PS when light intensity of the backlight light Lb1 varies under conditions that no light is illuminated from the screen side of the image display device of the present embodiment. The currents Ip3 and Ip4 are electric current of the photo-sensing TFT 3 and electric current of the photo-sensing TFT4, respectively. The currents Ip3′ and Ip4′ are current of the photo-sensing TFT 3 and current of the photo-sensing TFT4, respectively, at light intensity LV2 of the backlight Lb1. When assuming that leak current that is derived from dark current flowing the photo-sensing TFT3 and the photo-sensing TFT4 is Ioff, photo-electric current that flows the photo-sensing TFT3 and the photo-sensing TFT4 when the backlight light Lb1 with light intensity LV1 is illuminated is ILV1 and photo-electric current that flows the photo-sensing TFT3 and the photo-sensing TFT4 when the backlight light Lb1 with light intensity LV2 is illuminated is ILV2, the current Ip3, Ip4, Ip3′ and Ip4′ can be expressed as follows:

Ip3=Ioff+ILV1;

Ip4=Ioff+ILV1;

Ip3′=Ioff+ILV2, and

Ip4′=Ioff+ILV2

### Here, the light intensity LV2 shall be higher than the light intensity LV1.

When the backlight light Lb1 with light intensity LV1 is illuminated from the lower side of the glass substrate 27, the photo-electric current Ip3 flows in the photo-sensing TFT3, the photo-electric current Ip4 flows in the photo-sensing TFT4, and the voltage VA at the node A2 becomes stable at the potential VA1. Then, light intensity of the backlight light Lb1 increases to LV2 from LV1 and the backlight light Lb1 having the same light intensity is illuminated on the photo-sensing TFT3 and the photo-sensing TFT4, which causes the photo-electric current Ip3 and Ip4 to be the photo-electric current Ip3′ and Ip4′ respectively whose electric current amount has increased by the same amount. As a result, potential of the voltage VA remains same at VA1. It should be noted that, in FIG. 5, ΔI shows increment in electric current caused by light illumination. Therefore, under the condition that no light is illuminated from the screen of the image display device of the present embodiment, voltage at the terminal A of the photo-sensing circuit PS does not vary even if light intensity of backlight has varied.

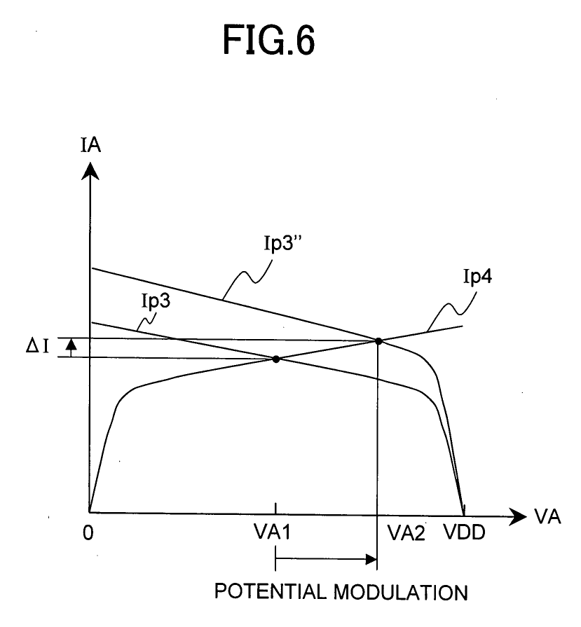

FIG. 6 shows a diagram illustrating relationship between electric current IA and potential VA at the terminal A of the photo-sensing circuit PS when light is illuminated from the screen side of the image display device of the present embodiment. The currents Ip3 and Ip4 are electric current of the photo-sensing TFT 3 and electric current of the photo-sensing TFT4 at light intensity LV1 of the backlight light Lb1, respectively. The current Ip3″ is electric current that flows in the photo-sensing TFT3 when the reflected light Lref on the finger 51 at the time of touching the screen of the image display device is incident toward the photo-sensing circuit SEN.

Assuming that photo-electric current that flows in the photo-sensing TFT3 when the light Lref is incident on the screen is Iref, the current Ip3″ can be expressed as Ip3″=Ioff+ILV1+Iref. When the backlight light Lb1 with light intensity LV1 is illuminated from the lower side of the glass substrate 27, the photo-electric current Ip3 flows in the photo-sensing TFT3, and the photo-electric current Ip4 in the photo-sensing TFT4, when the voltage VA of the node A is stabilized at the potential VA1. Then, illumination of the light Lref on the photo-sensing TFT3 on the screen increases the current to the photo-electric current Ip3″, and, therefore, potential of the voltage VA is modulated to VA2 from VA1.

Consequently, electric current of the photo-sensing TFT3 increases, under the condition that the backlight light Lb1 is illuminated from the lower side of the photo-sensing TFT3 and the photo-sensing TFT4, and, not depending on light intensity of the backlight 29, but depending on light intensity of the light that illuminated the screen, and the voltage at the terminal A of the photo-sensing circuit PS is modulated.

According to FIGS. 5 and 6, the photo-sensing circuit PS in the image display device of the present embodiment offsets influence of the backlight light Lb1 by way of the photo-sensing TFT3 and the photo-sensing TFT4, and outputs the changed portion of voltage at the terminal A that relates to changed portion of light intensity of the touch-reflected light Lref when the reflected light Lref of the finger 51 which touched the screen illuminates the photo-sensing circuit. With such arrangement, it is possible to detect changes in the touch-reflected light Lref, without depending on light intensity of the light Lb1 of the backlight 29 or the current Ioff that is derived from dark current of the photo-sensing TFT3 and the photo-sensing TFT4.

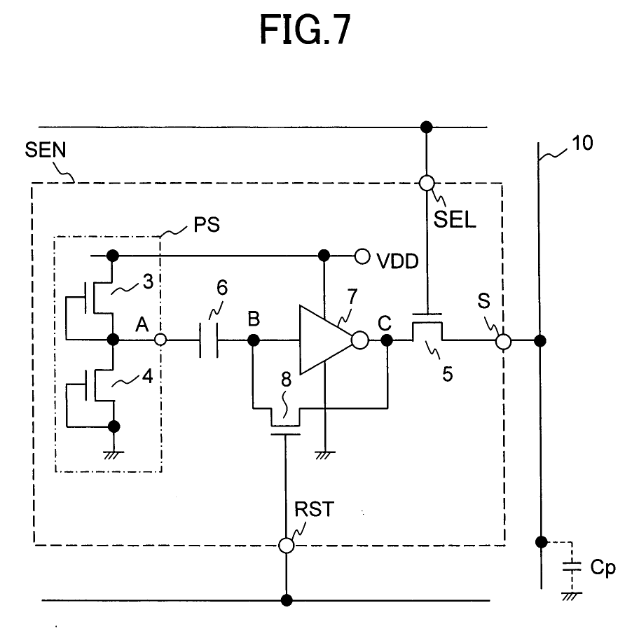

FIG. 7 shows a circuit diagram of the photo-sensing circuit SEN in the image display device of the present embodiment. The photo-sensing circuit SEN of the present embodiment includes the photo-sensing circuit PS which comprises the photo-sensing TFT3 and the photo-sensing TFT4, a capacitor 6, an inverter amplifier 7, a reset TFT 8 and a read TFT 5, and is further provided with three terminals RST, SEL and S. Furthermore, an output signal wiring line 10 of the photo-sensing circuit SEN is connected to a terminal S and parasitic capacitor Cp is generated in the output signal wiring line 10.

The connection node A of the photo-sensing circuit PS is connected with an end of the capacitor 6. The other end of the capacitor 6, an input terminal of the inverter amplifier 7, and an end of the source-drain path of the reset TFT 8 are connected to each other. The other end of the reset TFT 8 is connected to the output terminal of the inverter amplifier 7. An end of the source-drain path of the read TFT 5 is connected to the connection node C of the inverter amplifier 7, and the other end thereof is connected to the terminal S.

To the gate electrode of the reset TFT 8, a reset signal which is turned on in a prescribed cycle is input via the terminal RST. To the gate electrode of the read TFT 5, a read signal which is turned on in a prescribed cycle is input via the terminal SEL. The voltage at the terminal S which is connected to the output terminal of the inverter amplifier 7 is read out to the output signal line 10, and the voltage at the terminal S is held in the parasitic capacitor Cp.

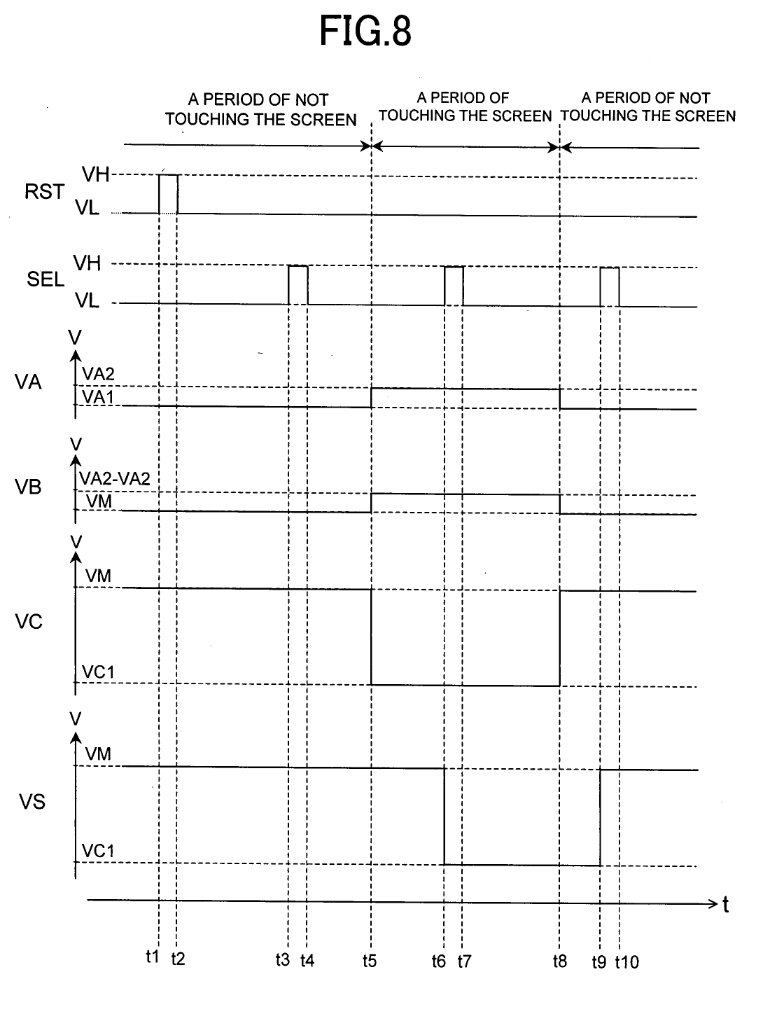

FIG. 8 is a timing chart illustrating voltage waveforms (RST, SEL) that are fed to the photo-sensing circuit SEN and voltage waveforms (VA, VB, VC, VS) that are generated in the photo-sensing circuit SEN. The voltage waveforms VA, VB, VC and VS are respectively those at the nodes A, B, C and S of the photo-sensing circuit SEN shown in FIG. 7, respectively.

Times t1 to t5 show periods during which the screen is not touched, times t5 to t8 show periods during which the screen is touched, and times t8 to T10 show periods during which the screen is not touched.

Hereinafter, the periods during which the screen is not touched (periods of times t1 to t5) will be described. At the time t1, voltage of the reset signal RST rises from low voltage VL to high voltage VH, the reset TFT 8 is turned on, the voltage waveforms VB and VC reach reset voltage VM [V] which is equivalent to the threshold voltage of the inverter amplifier, and potential difference of VM−VA1 [V] is generated in the capacitor 6 since the potential of VA is stable at VA1 [V].

At the time t2, voltage of the reset signal RST falls to low voltage VL from high voltage VH, the reset TFT 8 is turned off and the node B is in the floating status. However, the voltage VA stays unchanged at potential VA1 [V], and VB and VC do not change from the reset voltage VM [V]. During the period when a reset signal RST1 stays at the low voltage VL, the node B continues to be in the floating status.

On the other hand, since the read signal SEL 1 is kept at the low voltage VL, the read TFT 5 is turned off, and in the parasitic capacitor Cp, the potential VM [V] status of VS when the read TFT 5 is turned on is held.

At the time t3, the read signal SEL rises to high voltage VH from low voltage VL and the read TFT 5 is turned on, which makes the node C and the terminal S conductive each other. The voltage VS is read out to the output signal line 10 as potential VM [V] of the voltage VC, and the voltage VM [V] is sampled.

At the time t4, the read signal SEL falls to low voltage VL from high voltage VH and the read TFT 5 is turned off, which holds the potential VM [V] status of VS when the read TFT 5 is turned on in the parasitic capacitor Cp of the output signal line 10.

Hereinafter, the periods during which the screen is touched (periods of times t5 to t8) will be described. At the time t5, touching on the screen of the image display device with the finger 51 the backlight light Lb1 is reflected on the finger 51 which touched the screen, and light Lref 3 is incident on the photo-sensing circuit SE. Then, potential of VA of the photo-sensing circuit PS is modulated to VA 2 [V] from VA 1 [V], and, following VA, potential of VB is modulated to VA 2+VM−VA 1. As a result, amplitude VA 2−VA 1 [V] of input signal of VB is input to the inverter amplifier 7, and potential VC 1 of VC will be VM+AG (VA 2−VA 1) [V]. Here, AG is the amplifying ratio of the inverter amplifier 7 at the threshold voltage VM.

As described in the above, the modulation potential VA 2−VA 1 [V] of VA is amplified in the inverter amplifier 7 to be VM+AG (VA 2−VA 1) [V]. Therefore, since influence of fluctuations in the threshold voltage VM becomes smaller as the amplifying ratio AG of the inverter amplifier 7 becomes larger, it is possible to restrict influences of mobility or fluctuated threshold values of individual inverter amplifier 7 of the photo-sensing circuit SEN that are made in a matrix form on the glass substrate 27.

At the time t6, the read signal SEL rises to high voltage VH from low voltage VL and the read TFT 5 is turned on, which makes the node C and the terminal S conductive each other, VS is read out to the output signal line 10 as potential VC 1 [V] of VC, and the potential VC 1 [V] is sampled.

At the time t7, the read signal SEL falls to low voltage VL from high voltage VH and the read TFT 5 is turned off, which holds the potential VC 1 [V] status of VS when the read TFT 5 is turned on in the parasitic capacitor Cp of the output signal line 10.

Hereinafter, the periods during which the screen is not touched (periods of times t8 to t10) will be described. At the time t8, releasing of the finger 51 that touched the screen, potential of VA is demodulated to VA 1 from VA 2, VB changes to potential VM [V] while retaining the potential difference that is held in the capacitor 6, and it becomes potential VM [V] of VC.

At the time t9, the read signal SEL rises to high voltage VH from low voltage VL and the read TFT 5 is turned on, which makes the node C and the terminal S conductive each other, VS is read out to the output signal line 10 as potential VM [V] of VC, and the potential VM [V] is sampled. At the time t10, the read signal SEL falls to low voltage VL from high voltage VH and the read TFT 5 is turned off, which holds the potential VM [V] status of VS when the read TFT 5 is turned on in the parasitic capacitor Cp of the output signal line 10.

With the above-described operations, since the photo-sensing circuit SEN of the present embodiment stores potential modulation at the terminal A of the photo-sensing circuit PS at a time before or after a certain time period as potential difference of the capacitor 6 and amplifies the changed portion in the inverter amplifier 7, the photo-sensing circuit SEN amplifies the changed portion in the inverter amplifier 7 and output it to the terminal S as the output signal voltage VS even if change in the reflected light Lref of the finger 51 by touching the screen is very minute.

According to FIGS. 7 and 8, the photo-sensing circuit SEN in the image display device of the present embodiment offsets influence of the backlight light Lb1 by way of the photo-sensing TFT3 and the photo-sensing TFT4, and outputs the changed portion of voltage at the terminal A that relates to changed portion of light intensity of the touch-reflected light Lref when the reflected light Lref of the finger 51 which touched the screen illuminates the photo-sensing circuit. With such arrangement, it is possible to detect changes in the touch-reflected light Lref, without depending on light intensity of the light Lb1 of the backlight 29 or the current Ioff that is derived from dark current of the photo-sensing TFT3 and the photo-sensing TFT4. It is further possible to transmit potential modulation at the terminal A to the inverter amplifier 7, and immediately read the potential modulation to a signal line as amplified output voltage. In addition, since storage of electric charge of signal and resetting operation thereof are not necessary, there is no problem that output voltage cannot be obtained depending on timing of a touch, thus enabling to provide an image display device that features high S/N ratio and enables high-speed sensing.

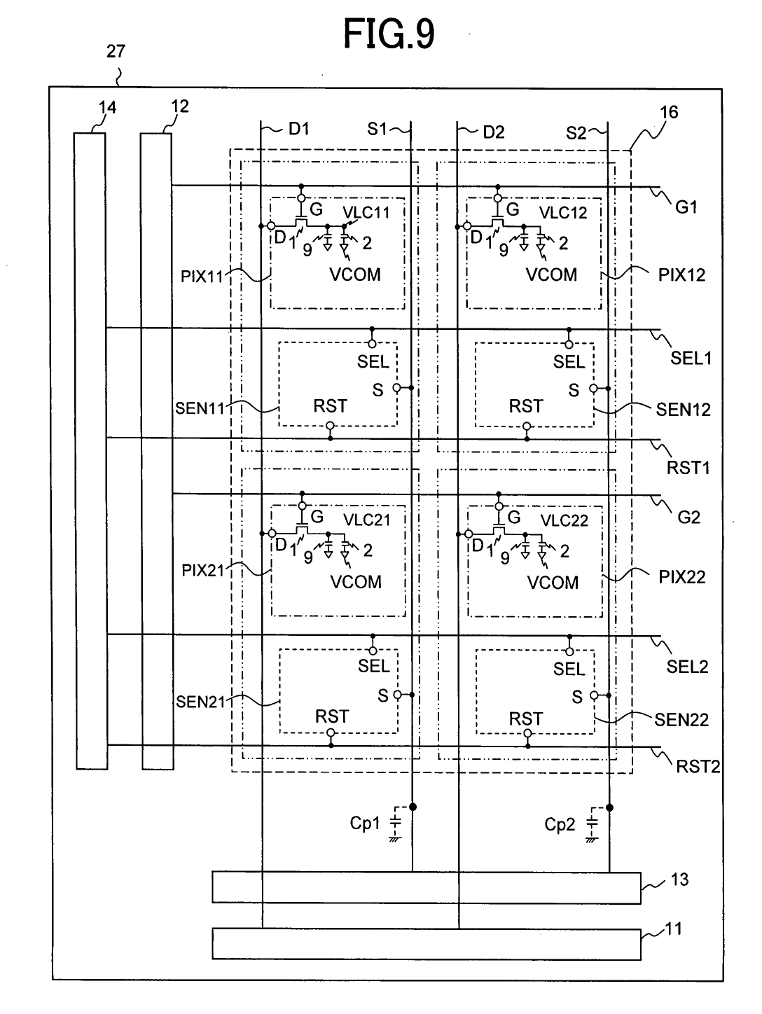

FIG. 9 shows a circuit configuration of the image display device of the present embodiment. A data driver circuit 11, a scan circuit 12, a sensor circuit 13 and a sensor gate line selection circuit 14 are formed on the glass substrate 27. The glass substrate is a substrate that is generally used in a low-temperature polysilicon manufacturing process. However, the substrate material is not limited to glass so far as insulation properties of the surface can be ensured. In the display area 16, a plurality of data lines D1 and D2 from the data driver circuit 11, and sensor output signal lines S1 and S2 that are connected to the sensor circuit 13 are arranged in a vertical direction. While, a plurality of gate lines G1 and G2, and a plurality of sensor reset gate lines RST 1 and RST 2 as well as a plurality of sensor gate lines SEL1 and SEL2 from the scan circuit 12 are arranged in a horizontal direction.

At each intersection of the wiring lines arranged in vertical direction and those arranged in horizontal direction, display pixel circuits PIX 11, PIX 12, PIX 21 and PIX 22 and photo-sensing circuits SEN 11, SEN 12, SEN 21 and SEN 22 are arranged in a pair, respectively. Here, to simplify description, only two data lines, two gate lines, four (2×2) display pixel circuits PIX, four (2×2) photo-sensing circuits, two reset signal lines and two read signal lines are shown. However, several hundreds of such lines and circuits exist in an actual image display device. For example, the image display device features color display and resolution of VGA, the number of the data lines will be 640×3 (RGB)=1,920, the number of the gate lines will be 480, and the number of the display pixel circuits PIX and the photo-sensing circuits SEN will be 640×3×480=921,600, respectively.

Here, the display pixel circuits PIX 11, PIX 12, PIX 21 and PIX 22 have the same configuration, and each display pixel circuit PIX includes a display pixel TFT 1, a liquid crystal 2 and an storage capacitor 9. Then, a voltage waveform G1′ is input to a gate electrode G of the display pixel TFT 1 of the display pixel circuits PIX 11 and PIX 12, a voltage waveform G2 to the gate electrode G of the display pixel TFT 1 of the display pixel circuits PIX 21 and PIX 22, a voltage waveform D1 to a drain electrode D of the display pixel TFT 1 of the display pixel circuits PIX 11 and PIX 12, and a voltage waveform D2 to the drain electrode D of the display pixel TFT 1 of the display pixel circuits PIX 21 and PIX 22.

Further, the photo-sensing circuits SEN 11, SEN 12, SEN 21 and SEN 22 have the same configuration as that of the photo-sensing circuit SEN shown in FIG. 7. The reset signal line RST 1 and the read signal line SEL from the gate line selection circuit 14 are respectively connected to the terminals RST and SEL of the photo-sensing circuits SEN 11 and SEN 12. In a similar way, the reset signal line RST 2 and the read signal line SEL 2 from the gate line selection circuit 14 are respectively connected to the terminals RST and SEL 1 of the photo-sensing circuits SEN 21 and SEN 22.

Then, an output signal line S1 is connected to terminal S of the photo-sensing circuits SEN 11 and SEN 21, output voltage VS 1 of the photo-sensing circuit SEN is transmitted to the sensor circuit 13, an output signal line S2 is connected to terminal S of the photo-sensing circuits SEN 12 and SEN 22, and output voltage VS 2 of the photo-sensing circuit SEN is transmitted to the sensor circuit 13.

In the configuration described above, the display pixel circuit PIX displays an image in the following procedures: The gate electrode G is turned on by supplying gate signal to be output from the scan circuit 12 in a form of cyclic pulses; Potential difference between voltage VLC of the display electrode 48 and voltage VCOM of the counter electrode 22 is generated by supplying data voltage to the drain electrode D; Alignment of liquid crystal molecular is changed by applying an electric field across the display electrode 48 and the counter electrode 22 shown in FIG. 2; and further, turning on and off of light Lb1 of the backlight 29 is controlled by using two defector plate the lower deflector plate 28 and the upper deflector plate 20.

The photo-sensing circuit SEN, which is formed on the glass substrate 27, reads out, to output signal lines S1, S2, a change in amount of reflected light Lref from the finger 51 that has touched the screen of the image display device as a change in voltage. Then, the photo-sensing circuit SEN transmits an output voltage VS to the sensor circuit 13. This allows the photo-sensing circuit 27 to detect whether or not the screen has been touched.

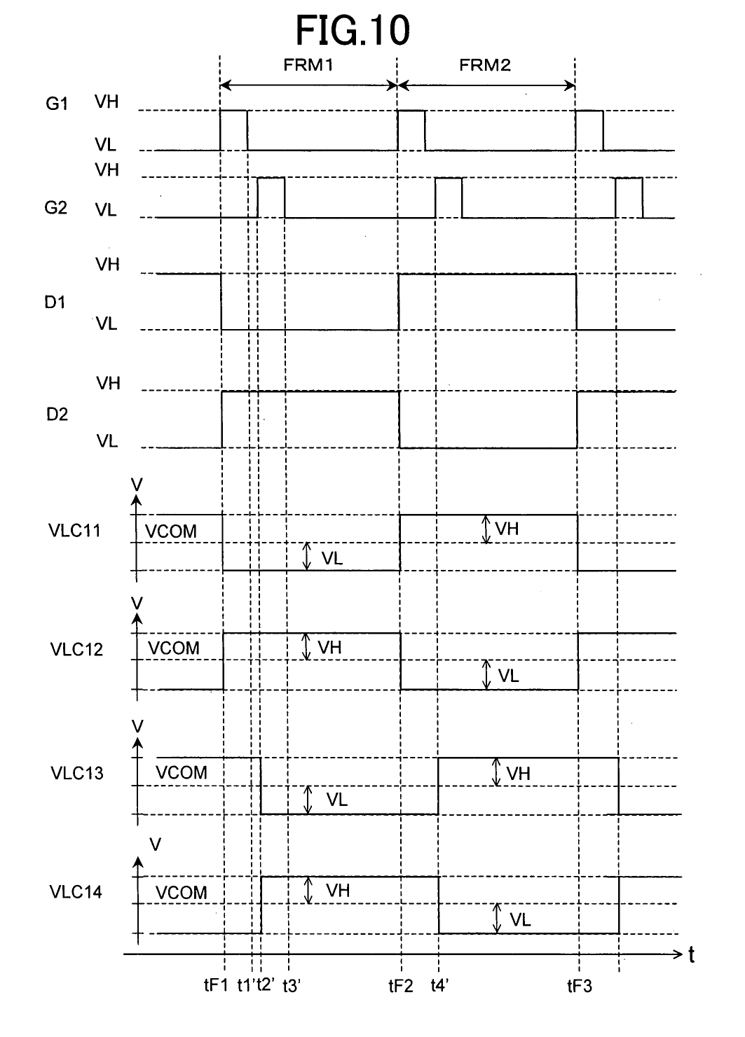

FIG. 10 shows voltage waveforms (G1, G2, D1 and D2) which drive the display pixel circuit PIX and voltage waveforms (VLC 11, VLC 12, VLC 21 and VLC 22) that are generated in the display pixel circuit PIX.

Here, to simplify description, the image display device of the present embodiment is of liquid crystal of a normally-black mode TN type, wherein a drive system of the inverted-frame type in which image polarity is inverted for each frame. Therefore, the polarities of the data lines D1 and D2 are inverted for each first frame period FRM 1 (time tF1 to tF2) and second frame period FRM 2 (time tF2 to tF3). A voltage with a reversed phase of the data line D1 is input to the data line D2.

Hereinafter, drive timing in the first frame (tF1 to tF2) will be described. At the time tF1, rewriting of data of the display pixel circuits PIX 11 and PIX 12 is executed. The gate line G1 rises to high voltage VH from low voltage VL, which causes the gate electrode of the display pixel circuits PIX 11 and PIX 12 connected to the gate line G1 to be turned on. Falling of potential of the data line D1 to low voltage VL from high voltage VH causes the voltage VL to be fed to the drain electrode of the display pixel circuit PIX 11, and rising of potential of the data line D2 to VH from VL causes the voltage VH to be fed to the drain electrode of the display pixel circuit PIX 12.

Then, electric charge is charged in the storage capacitor 9 of respective liquid crystal of the display pixel circuits PIX 11 and PIX 12, which causes display electrode potential VLC 11 of the display pixel circuit PIX 11 to be the same level as potential VL of the data line D1, and electrode potential VLC 12 of the display pixel circuit PIX 12 to be the same level as potential VH of the data line D2.

For the display pixel circuit PIX 11, since potential of the data line D2 is VL when the gate line G1 is in high voltage VH, the display pixel circuit PIX 11 has negative potential difference VL across the potential VLC 11 of the display electrode and the voltage VCOM of the counter electrode. Consequently, no electric field is applied to liquid crystal material and backlight light does not penetrate the screen up to the surface thereof, resulting in display of black image on the screen.

For the display pixel PIX 12, since potential of the data line D2 is VH when the gate line G1 is in high voltage VH, the display pixel circuit PIX 12 has positive potential difference VL across the potential VLC 12 of the display electrode and the voltage VCOM of the counter electrode. Consequently, an electric field is applied to liquid crystal material and backlight light penetrates the screen up to the surface thereof, resulting in display of white image on the screen.

At the time t1′, falling of the gate line G1 to low voltage VL from high voltage VH causes the gate electrode of the display pixel circuits PIX 11 and PIX 12 connected to the gate line G1 to be turned off. As a result, no voltage is fed from the data lines D1 and D2, and electric charge is held in the storage capacitor 9 until the time tF2.

At the time t2′, rewriting of data of the display pixel circuits PIX 21 and PIX 22 is executed. When the gate line G2 rises to high voltage VH from low voltage VL, since potential of the data line D1 is VL and potential of the data line D2 is VH when the gate electrode of the display pixel circuits PIX 21 and PIX 22 connected to the gate line, the voltage VL is fed to the drain electrode of the display pixel circuit PIX 21 and the voltage VH to the drain electrode of the display pixel circuit PIX 22. Then, electric charge is charged to the storage capacitor 9 of respective liquid crystal of the display pixel circuits PIX 21 and PIX 22, display electrode potential VLC 21 of the display pixel circuit PIX 21 reaches the same level as the potential VL of the data line D1, and display electrode potential VLC 22 of the display pixel circuit PIX 22 reaches the same level as the potential VH of the data line D2.

For the display pixel circuit PIX 21, since potential of the data line D2 is VL when the potential of the gate line G1 is VH, the display pixel circuit PIX 21 has negative potential difference VL across the potential VLC 21 of the display electrode and the voltage VCOM of the counter electrode. Consequently, no electric field is applied to liquid crystal material and backlight light does not penetrate the screen up to the surface thereof, resulting in display of black image on the screen.

For the display pixel PIX 22, since potential of the data line D1 is VH when the gate line G1 is in high voltage VH, the display pixel circuit PIX 22 has potential difference VL across the potential VLC 22 of the display electrode and the voltage VCOM of the counter electrode. Consequently, backlight light penetrates the screen up to the surface thereof, resulting in display of white image on the screen.

At the time t3′, falling of the gate line G1 to low voltage VL from high voltage VH causes the gate electrode of the display pixel circuits PIX 21 and PIX 22 connected to the gate line G1 to be turned off. As a result, no voltage is fed from the data lines D1 and D2, and electric charge is held in the storage capacitor 9 until the time tF2.

At the time tF2, G1 rises to high voltage VH from low voltage VL, polarities of data lines D1 and S2 are inverted, and the images on the screen corresponding to the display pixel circuits PIX 11 and PIX 21 are inverted to black display form white display.

At the time t4′, G2 rises to high voltage VH from low voltage VL, polarity is inverted at the time tF2, and the images on the screen corresponding to the display pixel circuits PIX 11 and PIX 21 are inverted to black display from white display. In such a way, white and black stripe images can be displayed on the screen.

The foregoing description exemplifies operations during the first frame (tF1 to tF2). During the second frame (tF2 to tF3), polarities of the data lines D1 and D2 are inverted as opposed to the first frame. In association with this, except the fact that voltage across the voltage VLC 11 and VLC 22 of the display electrode is inverted, it is possible to display images by using display signals on the display unit 16 which includes a plurality of pixels, by repeating operations similar to those of the first frame. As stated above, images according to voltages of data signals are displayed by repeating the frames.

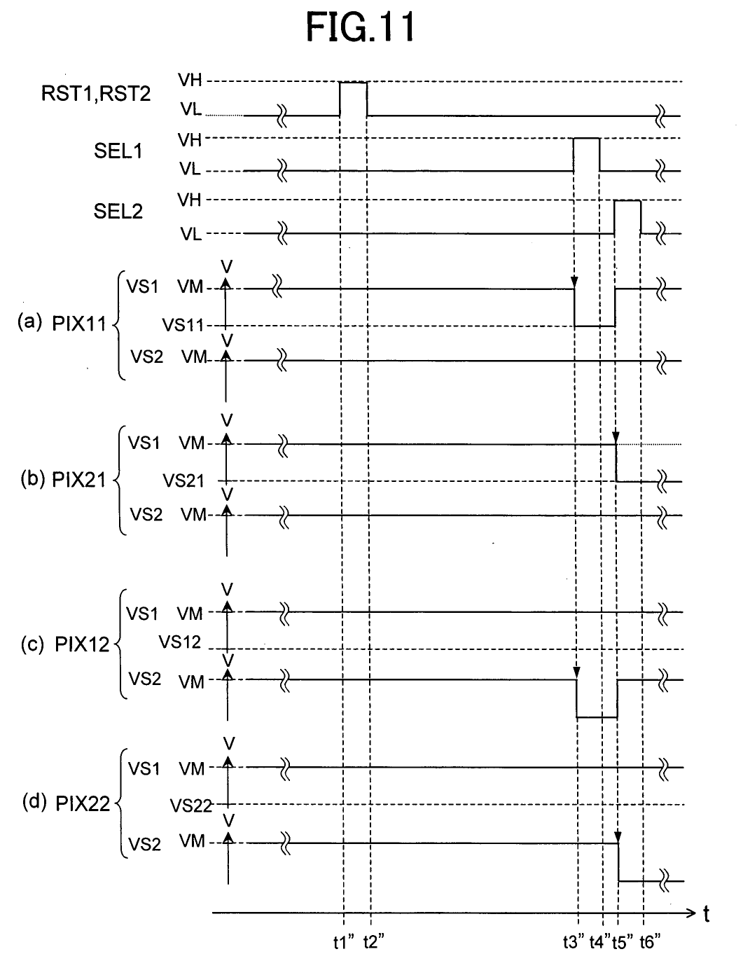

FIG. 11 shows operation waveforms for detecting the reflected light Lref in the photo-sensing circuits SEN 11 to SEN 22 of the image display device of the embodiment shown in FIG. 9. The reset signal lines RST 1, RST 2, the read signal lines SEL 1 and SEL 2 are input to respective terminals of the photo-sensing circuits SEN 11 to SEN 22, and the output signals VS 1 and VS 2 are output from the photo-sensing circuits SEN 11 to SEN 22 to the signal output lines S1 and S2 and are then transmitted to the sensor circuit 13.

Referring to FIG. 11, FIG. 11A shows operation waveforms of the output signals VS 1 and VS 2 which are output from SEN 11 and SEN 12 when a point on the screen to be displayed by PIX 11 is touched with a finger, FIG. 11B shows operation waveforms of the output signals VS 1 and VS 2 which are output from SEN 21 and SEN 22 when a point on the screen to be displayed by PIX 21 is touched with the finger 51, FIG. 11C shows waveforms of the output signals VS 1 and VS 2 which are output from SEN 11 and SEN 12 when a point on the screen to be displayed by PIX 12 is touched with the finger 51, and FIG. 11D shows operation waveforms of the output signals VS 1 and VS 2 which are output from SEN 21 and SEN 22 when a point on the screen to be displayed by PIX 22 is touched with the finger 51.

First, FIG. 11A showing that waveforms of the signal lines S1 and S2 when a point on the screen to be displayed by PIX 11 is touched with a finger will be described.

Over the period of time t1″ to t2″, operations are similar to those of the voltage waveform RST that is fed to the photo-sensing circuit SEN as shown in FIG. 8. At the time t1″, the reset signals RST 1 and RST 2 rise to high voltage VH from low voltage VL. At the time T2″, the reset signal RST 2 falls to low voltage VL from high voltage VH. This causes the output signal VS 1 of the photo-sensing circuits SEN 11 to SEN 22 to be VM [V].

At the time t3″, the read signal SEL 1 rises to high voltage VH from low voltage VL, the voltage VS 11 [V] of the output signal VS 1 of the photo-sensing circuit SEN 11 is output to the signal line S1 to be sampled in a parasitic capacitor Cp1, the voltage VM [V] of the output signal VS 2 of the photo-sensing circuit SEN 12 is output to the signal line S2 to be sampled in a parasitic capacitor Cp2.

In addition, since the read signal SEL 2 is in low voltage VL, output signals of the photo-sensing circuits SEN 21 and SEN 22 are not output to the signal lines S1 and S2.

At the time t4″, when the read signal SEL 1 falls to low voltage VL from high voltage VH, the status of the voltage VS 11 [V] that was sampled during the time t3″ is held in the signal line S1 until the read signal SEL 1 rises to high voltage VH from low voltage VL, and the status of the voltage VM [V] that was sampled during the time t3″ is held in the signal line S2 until the read signal SEL 1 rises to high voltage VH from low voltage VL.

Over the period of time t5″ to t6″, since the read signal SEL 2 rises to high voltage VH from low voltage VL and the output signal VS 1 of the photo-sensing circuit SEN 21 is output to the signal line S1, the voltage VC 11 [V] of the output signal VS 1 of the photo-sensing circuit SEN 11 held in the signal line S1 changes to the voltage VM [V] of the output signal of the photo-sensing circuit SEN 21, and there is no change from the voltage VM [V] of the output signal of the photo-sensing circuit SEN 12 held in the signal line S1 to the voltage of the output signal of the photo-sensing circuit SEN 22. Thus, the status of the voltage VM [V] that is held in the signal line S2 is retained.

In addition, since the read signal SEL 1 is in low voltage VL, output signals of the photo-sensing circuits SEN 11 and SEN 12 are not output to the signal lines S1 and S2.

Now, FIG. 11B showing that operation waveforms of the signal lines S1 and S2 when a point on the screen to be displayed by PIX 21 is touched with a finger will be described.

Over the period of time t1″ to t2″, operations are similar to those of the voltage waveform RST that is fed to the photo-sensing circuit SEN as shown in FIG. 8, and respective output signal voltages of the photo-sensing circuit SEN 11 to SEN 22 are the reset potential VM [V].

At the time t3″, the read signals SEL 1 rise to high voltage VH from low voltage VL, the voltage VM [V] of the output signal S1 of the photo-sensing circuit SEN 11 is output to the signal line S1 to be sampled in the parasitic capacitor Cp1, the voltage VM [V] of the output signal of the photo-sensing circuit SEN 12 is output to the signal line S2 to be sampled in the parasitic capacitor Cp2.

At this time, since the read signal SEL 2 is in low voltage VL, output signals of the photo-sensing circuits SEN 21 and SEN 22 are not output to the signal lines S1 and S2. At the time t4″, when the read signal SEL 1 falls to low voltage VL from high voltage VH, the status of the voltage VM [V] that was sampled during the time t3″ is held in the signal line S1 until the read signal SEL 1 rises to high voltage VH from low voltage VL, and the status of the voltage VM [V] that was sampled during the time t3″ is held in the signal line S2 until the read signal SEL 1 rises to high voltage VH from low voltage VL.

Over the time t5″ to t6″, since the read signal SEL 2 rises to high voltage VH from low voltage VL and the output signal of the photo-sensing circuit SEN 21 is output to the signal line S1, the voltage VC 11 [V] of the output signal of the photo-sensing circuit SEN 11 held in the signal line S1 changes to the voltage VM [V] of the output signal of the photo-sensing circuit SEN 21, and there is no change from the voltage VM [V] of the output signal of the photo-sensing circuit SEN 12 held in the signal line S1 to the voltage of the output signal of the photo-sensing circuit SEN 22. Thus, the status of the voltage VM [V] that is held in the signal line S2 is retained.

In addition, since the read signal SEL 1 is in low voltage VL, output signals VS 1 and VS 2 of the photo-sensing circuits SEN 11 and SEN 12 are not output to the signal lines S1 and S2.

Now, FIG. 11C showing that operation waveforms of the signal lines S1 and S2 when a point on the screen to be displayed by PIX 12 is touched with a finger will be described.

Over the period of time t1″ to t2″, operations are similar to those of the voltage waveform RST that is fed to the photo-sensing circuit SEN as shown in FIG. 8, and respective output signal voltages of the photo-sensing circuit SEN 11 to SEN 22 will be the reset potential VM [V].

At the time t3″, the read signal SEL 1 rises to high voltage VH from low voltage VL, the voltage VM [V] of the output signal S1 of the photo-sensing circuit SEN 11 is output to the signal line S1 to be sampled in a parasitic capacitor Cp1, and the voltage VC 12 [V] of the output signal of the photo-sensing circuit SEN 12 is output to the signal line S2 to be sampled in a parasitic capacitor Cp2.

Further, since the read signal SEL 2 is in low voltage VL, output signals VS 1 and VS 2 of the photo-sensing circuits SEN 21 and SEN 22 are not output to the signal lines S1 and S2.

At the time t4″, when the read signal SEL 1 falls to low voltage VL from high voltage VH, the status of the voltage VM [V] that was sampled during the time t3″ is held in the signal line S1 until the read signal SEL 1 rises to high voltage VH from low voltage VL, and the status of the voltage VS 12 [V] that was sampled during the time t3″ is held in the signal line S2 until the read signal SEL 1 rises to high voltage VH from low voltage VL.

Over the time t5″ to t6″, since the read signal SEL 2 rises to high voltage VH from low voltage VL and the output signal of the photo-sensing circuit SEN 21 is output to the signal line S1, the voltage VM [V] of the output signal of the photo-sensing circuit SEN 11 held in the signal line S1 changes to the voltage VM [V] of the output signal of the photo-sensing circuit SEN 21, and there is no change from the voltage VS 12 [V] of the output signal of the photo-sensing circuit SEN 12 held in the signal line S1 to the voltage of the output signal of the photo-sensing circuit SEN 22. Thus, the status of the voltage VS 12 [V] that is held in the signal line S2 is retained.

In addition, since the read signal SEL 1 is in low voltage VL, output signals VS 1 and VS 2 of the photo-sensing circuits SEN 11 and SEN 12 are not output to the signal lines S1 and S2.

Now, FIG. 11D which shows that operation waveforms of the signal lines S1 and S2 when a point on the screen to be displayed by PIX 22 is touched with a finger will be described.

Over the period of time t1″ to t2″, operations are similar to those of the voltage waveform RST that is fed to the photo-sensing circuit SEN as shown in FIG. 8, and respective output signal voltages of the photo-sensing circuit SEN 11 to SEN 22 will be the reset potential VM [V]. At the time t3″, the read signal SEL 1 rises to high voltage VH from low voltage VL, the voltage VM [V] of the output signal S1 of the photo-sensing circuit SEN 11 is output to the signal line S1 to be sampled in a parasitic capacitor Cp1, and the voltage VM [V] of the output signal of the photo-sensing circuit SEN 12 is output to the signal line S2 to be sampled in a parasitic capacitor Cp2.

At this time, since the read signal SEL 2 is in low voltage VL, output signals VS 1 and VS 2 of the photo-sensing circuits SEN 21 and SEN 22 are not output to the signal lines S1 and S2.

At the time t4″, when the read signal SEL 1 falls to low voltage VL from high voltage VH, the status of the voltage VM [V] that was sampled during the time t3″ is held in the signal line S1 until the read signal SEL 1 rises to high voltage VH from low voltage VL, and the status of the voltage VM [V] that was sampled during the time t3″ is held in the signal line S2 until the read signal SEL 1 rises to high voltage VH from low voltage VL.

Over the time t5″ to t6″, since the read signal SEL 2 rises to high voltage VH from low voltage VL and the output signal of the photo-sensing circuit SEN 22 is output to the signal line S1, the status from the voltage VM [V] of the output signal of the photo-sensing circuit SEN 11 held in the signal line S1 to the voltage VM [V] of the output signal of the photo-sensing circuit SEN 22 is held. In the signal line S2, the voltage VM [V] of the output signal of the photo-sensing circuit SEN 12 held in the signal line S1 changes to the output signal of the photo-sensing circuit SEN 22. Thus, the status of voltage VS 22 [V] that is held in the signal line S2 is retained.

In addition, since the read signal SEL 1 is in low voltage VL, output signals VS 1 and VS 2 of the photo-sensing circuits SEN 11 and SEN 12 are not output to the signal lines S1 and S2.

By repeating the above-stated operations, the output terminal S of the photo-sensing circuits SEN 11 and SEN 21 is connected to the signal line S1, and the read signals SEL 1 and SEL 2 are input to the terminal SEL with some time lag. Thus, the output signal voltages VS 11 and VS 21 of the photo-sensing circuits SEN 11 and SEN 21 are read to the signal line S1 with some time lag, and the output signal voltages VS 11 and VS 21 are transmitted to the sensor circuit 13. Further, the output terminal S of the photo-sensing circuits SEN 12 and SEN 22 is connected to the signal line S1, the read signals SEL 1 and SEL 2 are input to the terminal SEL with some time lag. Thus, the output signal voltages VS 12 and VS 22 of the photo-sensing circuits SEN 12 and SEN 22 are read to the signal line S2 with some time lag, and the output signal voltages VS 12 and VS 22 are transmitted to the sensor circuit 13.

Consequently, by reading the output signal voltages of the signal lines S1 and S2 corresponding to a read signal, it is possible to grasp the coordinates of the point on the screen touched.

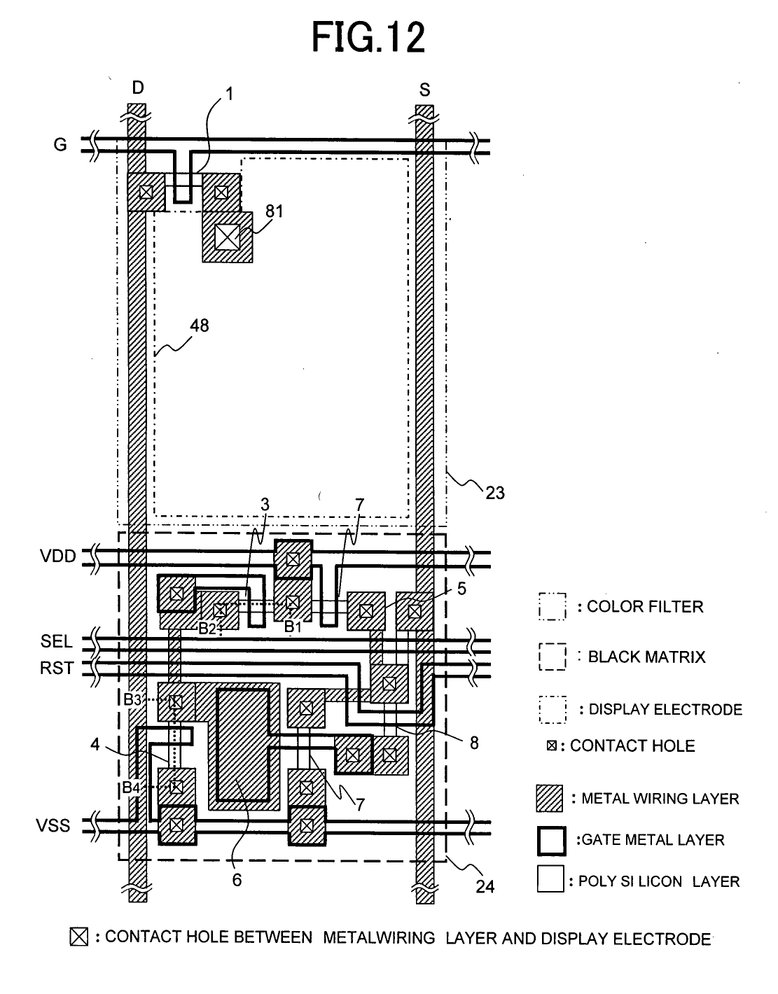

FIG. 12 shows a layout example of the display pixel circuit PIX and the photo-sensing circuit SEN. The source and the drain of each TFT are formed with the polysilicon layer 49 as shown in FIG. 2. Further, each wiring line of voltage VDD, VSS, RST, SEL, and gate line G as well as the gate electrode of each transistor are formed with the gate metal layer 43. Furthermore, data line D1, photo-sensing circuit output line S and remaining wiring lines are formed with the metal wiring layer 45.

The display electrode 48 is formed in a manner that it overlaps with most portions of components of the display pixel circuit PIX and the photo-sensing circuit SEN and is connected to the metal wiring layer 45 via a contact hole 81. A photo-sensing TFT 3, a photo-sensing TFT 4, a read TFT 5 and a reset TFT 8 which are circuit components of the photo-sensing circuit SEN and two TFTs 7 which configure the inverter amplifier 7 are formed by overlapping wiring lines of the gate metal layer 43 and wiring lines of the polysilicon layer 49. The black matrix 24 is provided over the components to shield light that is illuminated through the screen surface.

Further, the capacitor 6 is formed with the gate metal layer 43 and the metal wiring layer 45. The metal wiring layer 45 is connected to the polysilicon layer 49 of the photo-sensing TFT 4 through the contact hole 46. Furthermore, phosphor is doped in the polysilicon layer 49 that is placed next to all TFTs. The TFTs 3 to 5 and 8 and the inverter amplifier 7 function as n-channel TFTs.

Here, it should be noted that B1-B2 shown in FIG. 12 is a sectional diagram at section B1-B2 including the photo-sensing TFT 3 shown in FIG. 2, and that B3-B4 shown in FIG. 12 is a sectional diagram at section B3-B4 including the photo-sensing TFT 3 shown in FIG. 2.

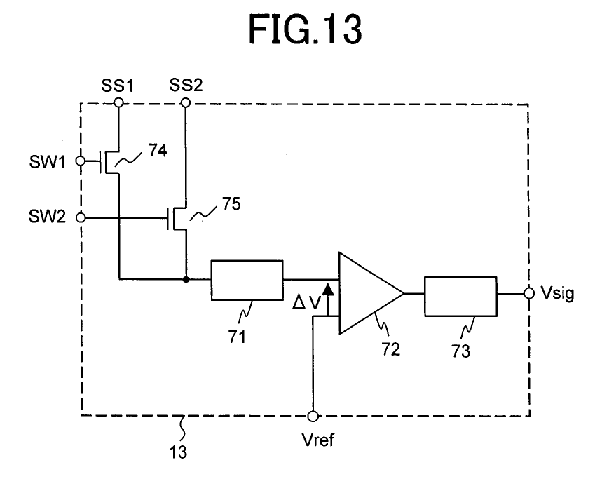

FIG. 13 shows the sensor circuit 13. The sensor circuit 13 includes a sample hold circuit 71, an amplifier 72, a latch circuit 73, a selection switch 74 and a selection switch 75. The sensor circuit 13 further includes terminals SS1 and SS2 connected to signal lines S1, S2, terminal switches SW1 and SW2 which controls the selection switch 74 and the selection 75, a terminal for inputting reference voltage Vref to the sample hold circuit 71, and a terminal Vsig connected to an output terminal from the latch circuit 73. More specifically, the sensor circuit forms a comparator circuit.

The terminals SS1 and SS2 connected to the signal lines S1 and S2 are further connected to the sample hold circuit 71 via the selection switch 74 and the selection switch 75. The terminal switches SW1 and SW2 are respectively connected to the gate electrodes of the selection switches 74 and 75. A signal is fed from the sensor gate line selection circuit 14. Signal voltages S1 and S2 to be input to the sample hold circuit 71 are then selected by controlling the selection switch 74 and the selection switch 75.

When the signal voltage S1 or S2 is input to the sample hold circuit 71, sampling is performed and sampling data is stored during a prescribed time period. During the period, the amplifier 72 amplifies difference ΔV between the sampling data and the judgment reference voltage Vref and delivers the difference to the latch circuit 73. The latch circuit 73, based on the signal delivered from the amplifier circuit 72, finally outputs a binary digital judgment signal Vsig.

An effect of the present embodiment is that the photo-sensing circuit SEN shown in FIG. 7 can detect a change in the touch-reflected light Lref without depending on light intensity of the light Lb1 of the backlight 26 or electric current Ioff which is derived from dark current of the photo-sensing TFT 3 and the photo-sensing TFT 4, by offsetting influence of the backlight light Lb1 by way of the photo-sensing TFT 3 and the photo-sensing TFT 4 and outputting the changed portion of voltage at the terminal A that relates to changed portion of light intensity of the touch-reflected light Lref when the reflected light Lref of the finger 51 which touched the screen illuminates the photo-sensing circuit. Further, it is possible to transmit potential modulation at the terminal A to the inverter amplifier and immediately read the potential modulation to a signal line as amplified output voltage.

In addition, since storage of electric charge of signal and resetting operation thereof are not necessary, there is no problem that output voltage cannot be obtained depending on timing of a touch.

Further, a change in light intensity of reflected light before and after input to the resetting TFT is stored as potential difference of the capacitor 6 and the changed portion is amplified by the inverter amplifier. Even if the change in the light reflected on finger when touching the screen is very minute, the changed portion is amplified by the inverter amplifier and is output to the sensor circuit as a signal voltage. Therefore, it is possible to know the coordinates of the point on the screen touched, by reading the output signal voltage of the signal line that corresponds to the read signal.

By arranging the photo-sensing circuit SEN of the present embodiment in a matrix, which is paired with a display pixel unit on the display unit 16, it is also possible to identify a touch at any point within the display unit 16 on the screen.

From the above description, according to the first embodiment of the present invention, it is possible to provide an image display device that enables light sensing at high S/N ratio, irrespective of luminance of backlight light or noise of dark current.

Further, since light signal current that is generated in a photo-sensing TFT is stored in a storage capacitor, there is no need to provide resetting control, thus enabling to provide an image display device that enables higher-speed reading of light signals.

Furthermore, according to the photo-sensing circuit of the present embodiment, it is possible to know the coordinates of the point on the screen touched, by reading the output signal voltage of the signal line that corresponds to the read signal.

Therefore, according to the present invention, high-speed reading of light signals at high S/N ratio is possible, and an image display device which is less affected by disturbance lights such as sunlight and illumination light that are incident on the screen and incorporates a touch panel function with less wrong recognition can be provided.

### Second Embodiment

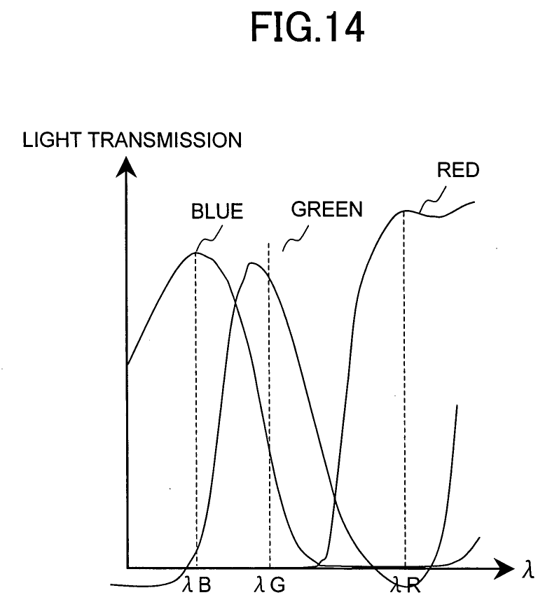

Hereinafter, a second embodiment of the image display device according to the present invention will be described in sequence concerning the configuration and operations thereof with reference to FIGS. 14 to 19.

FIG. 14 shows wavelength dependency of light transmittance of a general color filter that is used in the image display device of the second embodiment. The horizontal axis shows wavelength λ of light and the vertical axis shows light transmittance.

The light transmittance of a red color filter shows a curve that has its peak at wavelength λR. The light transmittance of a green color filter shows a curve having its peak at wave length λG. The light transmittance of a blue color filter shows a curve having its peak at wavelength λB. In general, the wavelength λB is around 450 nm; λG, around 550 nm; and λR, around 650 nm. The wavelength having highest light transmittance becomes larger in the order of blue, green and red color filters.

In particular, in the case of a liquid crystal image display device, the white light Lb1 of the backlight 29 is evenly illuminated on each of the red, green and blue (RBG) sub-pixels and is then dispersed by using RGB color filters for coloration. At this time, light transmittance is controlled by a voltage that is applied across the display electrode 48 and the counter electrode 22 from a data line. With such arrangement, the three primary colors of red, green and blue are added and mixed for implementing color display.

For the image display device of the second embodiment, surrounding light or the reflected light Lref on the finger 51 that touched the screen illuminates the screen, become incident on TFTs and penetrate the RGB color filters. The light penetrated an R filter 91 is dispersed to light LRref that matches the wavelength characteristics to have its peak at the wavelength λR, the light penetrated a G filter 92 is dispersed to light LGref that matches the wavelength characteristics to have its peak at the wavelength λG, the light penetrated a B filter 93 is dispersed to light LBref that matches the wavelength characteristics to have its peak at the wavelength λB, and the lights are incident on the photo-sensing circuit SEN.

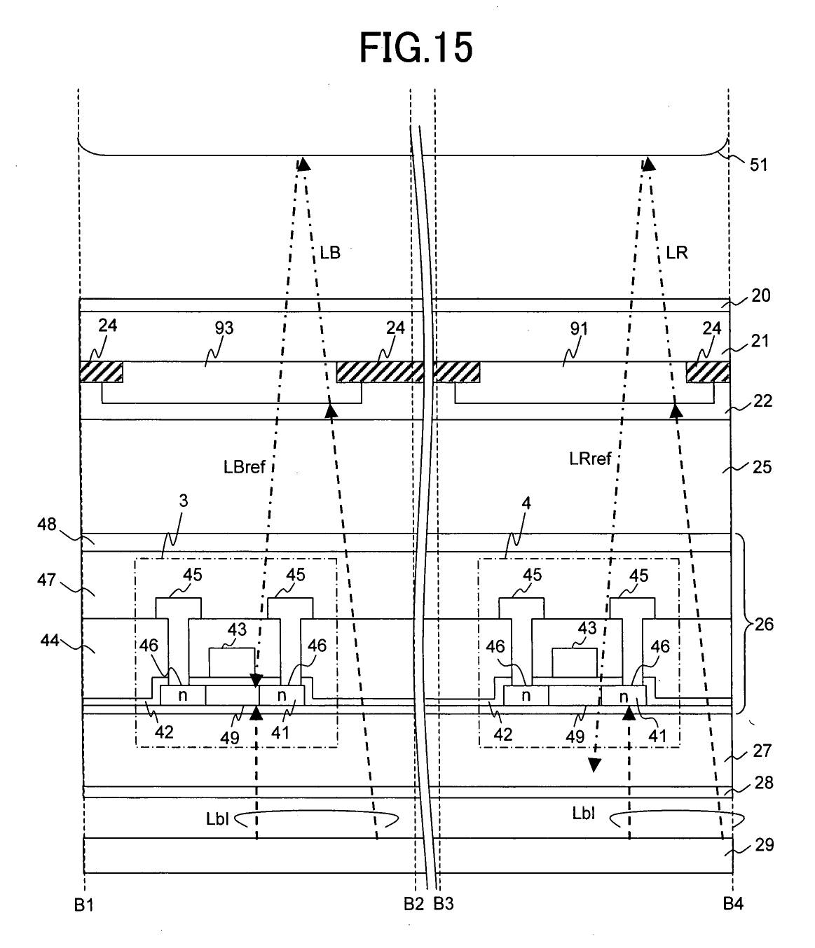

FIG. 15 shows a cross section structure of a light sensor unit SEN that is used in the image display device of the second embodiment. The image display device of the present embodiment includes a counter deflector plate 20 and a color filter side glass substrate 21, wherein the blue color filter 93, the red filter 91 and the black matrix 24 disposed between the blue color filter 93 and the red filter 91 are formed on the glass substrate 21. The image display device of the present embodiment further includes a counter electrode 22, a liquid crystal element 25, a glass substrate 27, a lower deflector plate 28 and a backlight 29.

The photo-sensing circuit SEN shown in FIG. 7 in the first embodiment stated above is formed on the glass substrate 27. More specifically, it is structured in the following ways: an insulation film 40 made of oxide silicon is formed on the glass substrate; a polysilicon layer 41 is formed on the insulation film 40; an n-type channel layer 49 is formed by doping n-type impurities in the polysilicon layer 41; a gate metal layer 43 is formed on the n-type channel layer 49 with a gate insulation film 42 sandwiched between the layer 43 and the layer 49; a metal wiring layer 45 is formed on the inter-layer insulation film 44 made on oxide silicon, the film 44 being sandwiched between the film 42 and the metal wiring layer 45, wherein the metal wiring layer 45 extends through the gate insulation film 42 and the inter-layer insulation film 44 with a contact hole 46 and is connected to the polysilicon layer 41 doped in n-type impurities, thus forming an electrode; and further on the metal layer 45, a display electrode 48 is formed with a planarizing insulation film 47 sandwiched in between the metal layer 45 and the display electrode 48. The structure is thus same as that of the image display device of the first embodiment shown in FIG. 2.

Here, a point that differs from the structure of the first embodiment is that the photo-sensing TFT 3 is formed beneath the blue color filter 93 and the photo-sensing TFT 4 is formed beneath the red color filter 91.

White light Lb1 that is illuminated by the backlight 29, after penetrating the lower deflector plate 28 and the glass substrate 27, illuminates the lower sides of the channel layers 49 of the photo-sensing TFT 3 and the photo-sensing TFT 4.

First, the light Lb1 of the back light 29 that penetrated at the side of the photo-sensing TFT 4 then penetrates the lower deflector plate 28, the glass substrate 27, the TFT substrate 26, the liquid crystal element 25, the counter electrode 22 and the red color filter 91. While the light LR that is dispersed into a red color component penetrates the color filter side glass substrate 21 and the color filter side deflector plate 20, the light LRref that was reflected on the finger 51 which touched the screen is incident again toward the photo-sensing TFT 4 and penetrates the color filter side deflector plate 20, the color filter side glass substrate 21, the red color filter 91, the counter electrode 22 and the liquid crystal element 25 before being incident on the channel layer 49 of the photo-sensing TFT 4.

On the other hand, the light Lb1 of the backlight 29 that penetrates the side of the photo-sensing TFT 3 then penetrates the lower deflector plate 28, the glass substrate 27, the TFT substrate 26, the liquid crystal element 25, the counter electrode 22, and the blue color filter 93. The light LB that is dispersed into a blue color component penetrates the filter side glass substrate 21 and the color filter side deflector plate 20, the light LBref that was reflected on the finger 51 which touched the screen is incident again toward the photo-sensing TFT 4 and penetrates the color filter side deflector plate 20, the color filter side glass substrate 21, the blue color filter 91, the counter electrode 22 and the liquid crystal element 25 before being incident on the channel layer 49 of the photo-sensing TFT 3.

Consequently, for the photo-sensing TFT 3, the backlight light Lb1 is illuminated at its lower side and the touch-reflected light LBref is illuminated at its upper side. For the photo-sensing TFT 4, the backlight light Lb1 is illuminated at its lower side and the touch-reflected light LRref is illuminated at its upper side.

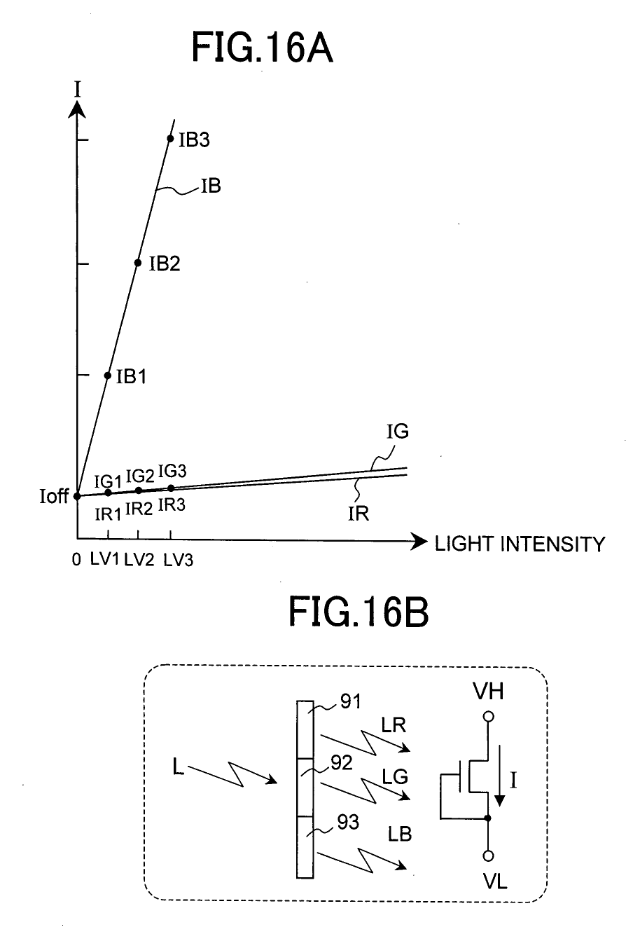

FIG. 16A shows dependency of light intensity of the light LR having wavelength of λR, the light LG having wavelength of λG, and the light LB having wavelength of λB, which penetrated the red filter 91, the green filter 92 and the blue filter 93 after the light L is illuminated on a TFT, and a drain current I. The horizontal axis shows light intensity of the light L that is illuminated on the TFT and the vertical axis shows the drain current I of the TFT.

As is the case with the description made for FIG. 3B of the first embodiment, by applying high potential VH to the drain of the TFT and low potential VL to the source of the TFT, as shown in FIG. 16B, to diode-connect the gate and the source, drain current I that is proportional to light intensity of the light LR, LG and LB flows in addition to drain current Ioff which is derived from dark current.

FIG. 16 shows the following three drain currents: drain current IR generated when the light LRref having wavelength of λR is illuminated on the TFT; drain current IG generated when the light LGref having wavelength of λG is illuminated on the TFT; and drain current IB generated when the light LBref having wavelength of λB is illuminated on the TFT. In this case, when drain current is assumed to be zero (0) when no light is illuminated on the TFT, the drain current IR increases to IR1, IR2 and IR3 as light intensity of the light Lref to be illuminated on the TFT increases to LV1, LV2 and LV3, the drain current IG to IG1, IG2 and IG3, and the drain current IB to IB1, IB2 and IB3.

The TFT used for the display TFT 2 and the photo-sensing circuit SEN of the image display device of the present embodiment is mainly made through a low-temperature polysilicon process. Since a polysilicon layer has film thickness of around 50 nm, as the light wavelength to be illuminates becomes shorter, the absorption rate of the polysilicon layer of the TFT becomes higher. Therefore, the light absorption factor becomes lower in the order of wavelength of λB, λG and λR. Consequently, compared with the drain current IB when the light LB having wavelength of λB is illuminated, current values of the drain current IG when the light LG having wavelength of λG and the drain current IR when the light LR having wavelength of λR is illuminated are very small.

For the TFT, the red filter 91 which disperses light to the wavelength λR or its vicinity at which the light transmittance reaches the peak and the green filter 92 which disperses light to the wavelength λR or its vicinity at which the light transmittance reaches the peak have an effect as a light shielding layer as is the case with the black matrix 24.

Therefore, with the light sensor circuit PS of the present embodiment, the photo-sensing TFT 3 is arranged beneath the blue filter 93 which disperses light to the wavelength λB or its vicinity at which the light transmittance reaches the peak and the photo-sensing TFT 4 is arranged beneath the red filter 91 which disperses light to the wavelength λR or its vicinity at which the light transmittance reaches the peak. With such arrangement, the photo-sensing circuit PS operates in a similar way to the photo-sensing circuit PS described in FIG. 4 of the first embodiment. In addition, there is no need to arrange the black matrix 24 on the photo-sensing TFT 4.

The structure and operations of the photo-sensing circuit PS used in the present embodiment are similar to those of the photo-sensing circuit PS of the first embodiment.

Voltage at the terminal A of the photo-sensing circuit PS of the embodiment is similar to the relationship between the current IA and the potential VA at the terminal of the terminal A of the photo-sensing circuit PS when light intensity of the backlight light Lb1 changes under the condition that light is illuminated from the screen side shown in FIG. 5 of the first embodiment, and potential at the node A2 is not modulated even if light intensity of the backlight changes.

With the embodiment, the role of shielding light of the photo-sensing TFT 4 is assigned to the red filter. Even under the condition that light is illuminated over the screen, the red filter shields light from the upper side of the screen. Therefore, as is the case with the relationship shown in FIG. 6 of the first embodiment, the light coming from the upper side of the screen is illuminated only on the photo-sensing TFT 3. Since light is illuminated on the channel layer 49 of the photo-sensing TFT 3, the photo-electric current increases, which results in potential modulation at the node A2.

Consequently, electric current of the photo-sensing TFT3 increases under the condition that the backlight light Lb1 is illuminated from the lower side of the photo-sensing TFT3 and the photo-sensing TFT4, and, not depending on light intensity of the backlight, but depending on light intensity of the light that illuminated the screen, and the voltage at the terminal A of the photo-sensing circuit PS is modulated.

From the above, also in the second embodiment, influence of the backlight light Lb1 is offset by way of the photo-sensing TFT3 and the photo-sensing TFT4, and only the changed portion of light intensity is output when the light reflected on the finger that touched the screen is illuminated on the photo-sensing TFT as the changed portion of voltage at the terminal A of the photo-sensing circuit PS.

Therefore, the photo-sensing circuit PS of the present embodiment, as is the case with the photo-sensing circuit PS of the first embodiment, by offsetting influence of the backlight light Lb1 by way of the photo-sensing TFT3 and the photo-sensing TFT4, and outputting the changed portion of voltage at the terminal A that is related to the changed portion of light intensity of the touch-reflected light Lref when the reflected light Lref of the finger that touched the screen is illuminated on the photo-sensing circuit, it is possible to detect a change in the touch-reflected light Lref without depending on light intensity of the light Lb1 of the backlight 26 or current Ioff which is derived from dark current of the photo-sensing TFT 3 and the photo-sensing TFT 4.

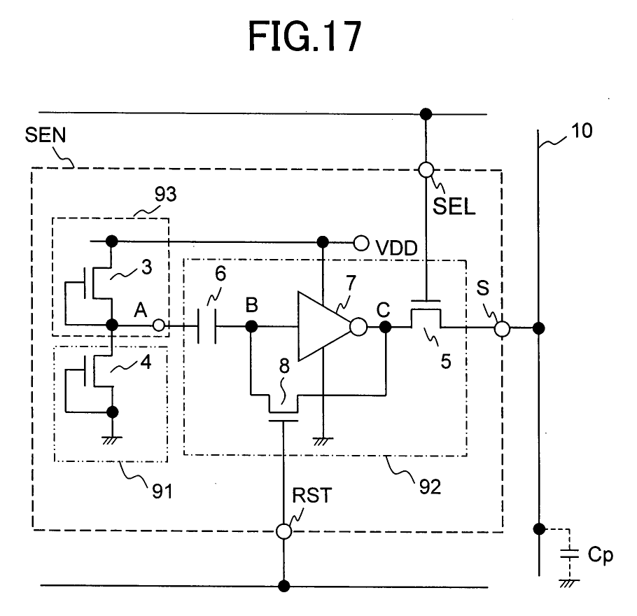

FIG. 17 shows a circuit diagram of the photo-sensing circuit SEN in the image display device of the present embodiment. Connection relationship between the photo-sensing TFT 3, the photo-sensing TFT 4, the capacitor 6, the inverter amplifier 7, the reset TFT 8, the read TFT 5, the RST terminal, the SEL terminal, the S terminal, the output signal wiring 10, the parasitic capacitor Cp and respective elements, which configure the photo-sensing circuit SEN of the present embodiment is same as that shown in FIG. 7 of the first embodiment.

Here, a point that differs from the structure of the first embodiment is that the blue filter 93 is arranged over the photo-sensing TFT 3 and the red filter over the photo-sensing TFT 4, and other elements are arranged beneath the green filter.

With such arrangement, since light to be illuminated on the screen can be shielded by the red filter 91, the photo-sensing TFT 4 functions as a shielding TFT, and there is no need to expand the area of the black matrix 24 for the purpose of providing a shield for the photo-sensing TFT 4. Further, concerning the capacitor 6, the inverter amplifier 7, the reset TFT 8 and read TFT 5 which are circuit elements that should be free from influence of light to be illuminated on the screen, light to be illuminated on the screen can be shielded by the green filter 92.

In the present embodiment, as is inherent in the first embodiment, there is no such problem that the light Lb1 of the backlight 29 is reflected on the metal layer to cause the photo-sensing TFT 4 to be exposed, which results in difference in exposure signal current between the photo-sensing TFTs 3 and 4. An exposure signal current Ib1 of the light Lb1 from the photo-sensing TFT 3 is originally equivalent to that from the photo-sensing TFT 4.

Further, by arranging the photo-sensing TFT 4 beneath the red filter, the light LR which is the dispersed light of sun light and illumination light in a room, which come on to pixels, and the screen touch-reflected light Lref by the red filter comes to have a property that it penetrates the photo-sensing TFT 4 without being absorbed in the channel thereof. This means that the light gives almost the same effect as in the case where it provides shielding over the channel.

Therefore, for the purpose of shielding the channel layer-49, there is no need to expand the area of the black matrix 24, or there is no need to increase the channel length as the metal wiring layer is expanded to ensure shielding. Thus, the photo-sensing TFT 3 and the photo-sensing TFT 4 can be formed in the same size, and expansion of area of the photo-sensing TFT 4 can be prevented.

By connecting, in series, the photo-sensing TFT 3 which is exposed to light of the backlight light reflected on a finger as a result of touching the screen and the photo-sensing TFT 4 which will not be exposed to light of the backlight light reflected on a finger as a result of touching the screen, operations that are similar to those described in FIG. 7 of the first embodiment can be obtained and a photo-sensing circuit having good sensitivity can be realized.

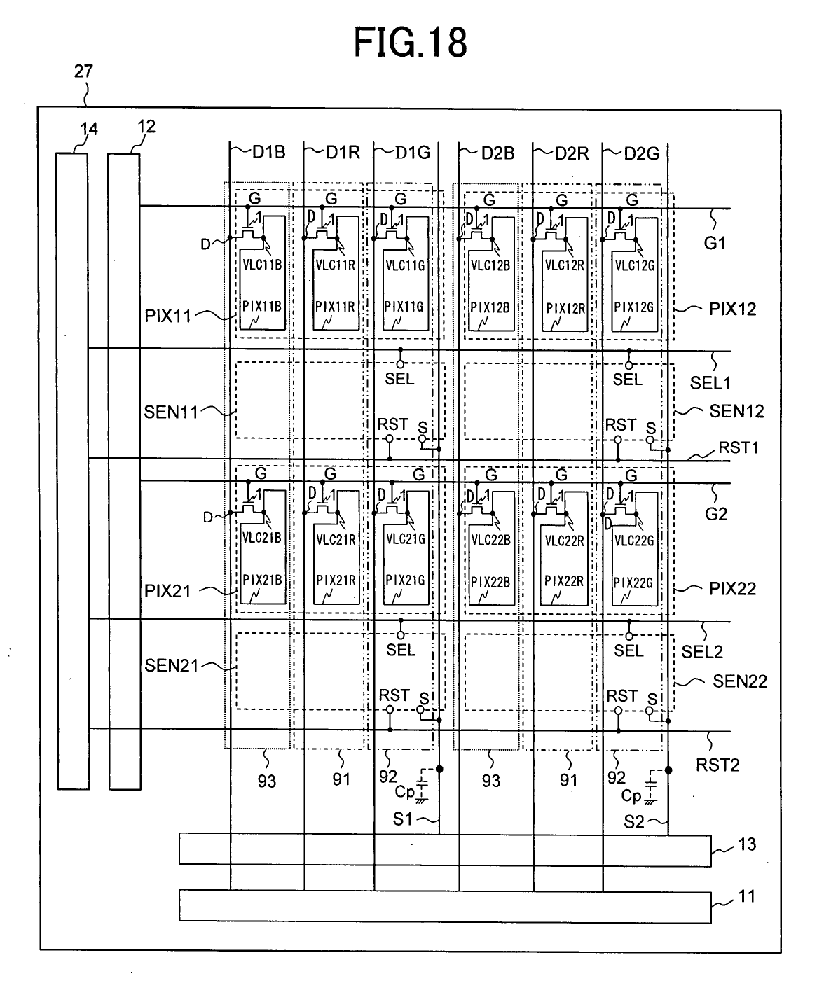

FIG. 18 shows a circuit configuration diagram of the image display device of the present embodiment. The circuit configuration of the present embodiment is basically similar to that of the first embodiment. In the circuit configuration according to the present embodiment, a data driver circuit 11, a scan circuit 12, a sensor circuit 13 and a sensor gate line selection circuit 14 are formed on the glass substrate 27. In addition, in a display area 16, a plurality of data line D1R, D1G, D1B, D2R, D2G and D2B as well as sensor output signal lines S1 and S2 that are connected to the sensor circuit 13 are arranged in a vertical direction, and a plurality of gate lines G1 and G2 from the scan circuit 12, a plurality of sensor reset gate lines RST 1 and RST 2 from the sensor gate line selection circuit 14 as well as a plurality of sensor gate lines SEL 1 and SEL 2 are arranged in a horizontal direction.

At each intersection of such wiring lines in the vertical direction and those in the horizontal direction, display pixel circuits PIX 11R, PIX 11G, PIX 11B and SEN 11 are arranged in a pair, PIX 12R, PIX 12G, PIX 12B and SEN 12 are arranged in a pair, PIX 21R, PIX 21G, PIX 21B and SEN 21 are arranged in a pair, and PIX 22R, PIX 22G, PIX 22B and SEN 22 are arranged in a pair.

In the present embodiment, RGB color filters are arranged in stripes, and the display pixel circuit PIX 11 includes three sub-pixels of the display pixel circuit PIX 11R which is formed beneath the red filter 91, the display pixel circuit PIX 11G which is formed beneath the green filter 92 and the display pixel circuit PIX 11B which is formed beneath the blue filter 93 and a photo-sensing circuit SEN 11.

Likewise, the display pixel PIX 12 includes three sub-pixels of PIX 12R, PIX 12G and PIX 12B and a photo-sensing circuit SEN 12. The display pixel PIX 21 includes three sub-pixels of PIX 21R, PIX 21G and PIX 21B and a photo-sensing circuit SEN 21. The display pixel PIX 22 includes three sub-pixels of PIX 22R, PIX 22G and PIX 22B and a photo-sensing circuit SEN 22.

The display pixel circuit PIX, as is the case with the first embodiment, includes the display pixel TFT 1, the liquid crystal 2 and the storage capacitor 9. Then, a voltage waveform G1 is input to gate electrodes G of the display pixel circuits PIX 11R, PIX 11G, PIX 11B, PIX 12R, PIX 12G and PIX 12B, a voltage waveform G2 to gate electrodes G of the display pixel circuits PIX 21R, PIX 21G, PIX 21B, PIX 22R, PIX 22G and PIX 22B, a voltage wave form D1 to drain electrodes D of the display pixel circuits PIX 11R, PIX 11G, PIX 11B, PIX 21R, PIX 21G and PIX 21B, and a voltage wave form G2 to drain electrodes D of the display pixel circuits PIX 12R, PIX 12G, PIX 12B, PIX 22R, PIX 22G and PIX 22B.

Further, the connection relationship of the reset signal line RST 1 and read signal line SEL 1 to the photo-sensing circuits SEN 11 and SEN 12, the connection relationship of the reset signal line RST 1 and read signal line SEL 2 to SEN 21 and SEN 22, and further, the connection relationship of the output signal line S1 and the photo-sensing circuits SEN 11 SEN 21 as well as the connection relationship of the output signal line S2 and the photo-sensing circuits SEN 12 SEN 22 are configured in a similar way to that shown in FIG. 7 of the first embodiment.

For the above-described configuration, the display pixel circuit PIX turns on the gate electrodes G by feeding the gate signal output from the scan circuit 12 as cyclic pulses, and feeds data voltage to the drain electrodes D, which generates a potential difference between the voltage VLC of the display electrode 48 and the voltage VCOM of the counter electrode 22. Further, by applying an electric filed across the display electrode 48 and the counter electrode 22 changes alignment of liquid crystal molecule of the liquid crystal 25, and further, by controlling turning on and off of the light Lb2 of the backlight 29 by using the two deflector plates of the deflector plate 28 and the upper deflector plate 20, a color image is displayed.

The photo-sensing circuit SEN reads a change in amount of the reflected light Lref of the finger 51 that touched the screen of the image display device to the output signal line as a change in voltage by the photo-sensing circuit SEN that is formed on the glass substrate 27, transmits the output voltage VS to the sensor circuit 13, thus enabling detection whether the screen was touched or not.

The display pixel circuit PIX in the pixel structure of the embodiment is driven in the following procedures: the data line voltage waveforms D1 and D2 shown in FIG. 10 of the first embodiment is replaced with D1R, D1G, D1B, D2R, D2G and D2B, and the waveform that is similar to the waveform of the first embodiment is supplied, which generates voltage in VLC 11R, VLC 11G, VLC 11B, VLC 12R, VLC 12G, VLC 12B, VLC 21R, VLC 21G, VLC 21B, VLC 22R, VLC 22G and VLC 22B at the display pixel electrode 48, thus displaying an image that associates with voltages of the data signal based on potential difference from the counter electrode VCOM.

In the pixel structure of the present embodiment, operation waveforms when reflected light is detected by the photo-sensing circuits SEN 11, SEN 12, SEN 21 and SEN 22 are similar to those shown in FIG. 11 of the first embodiment.

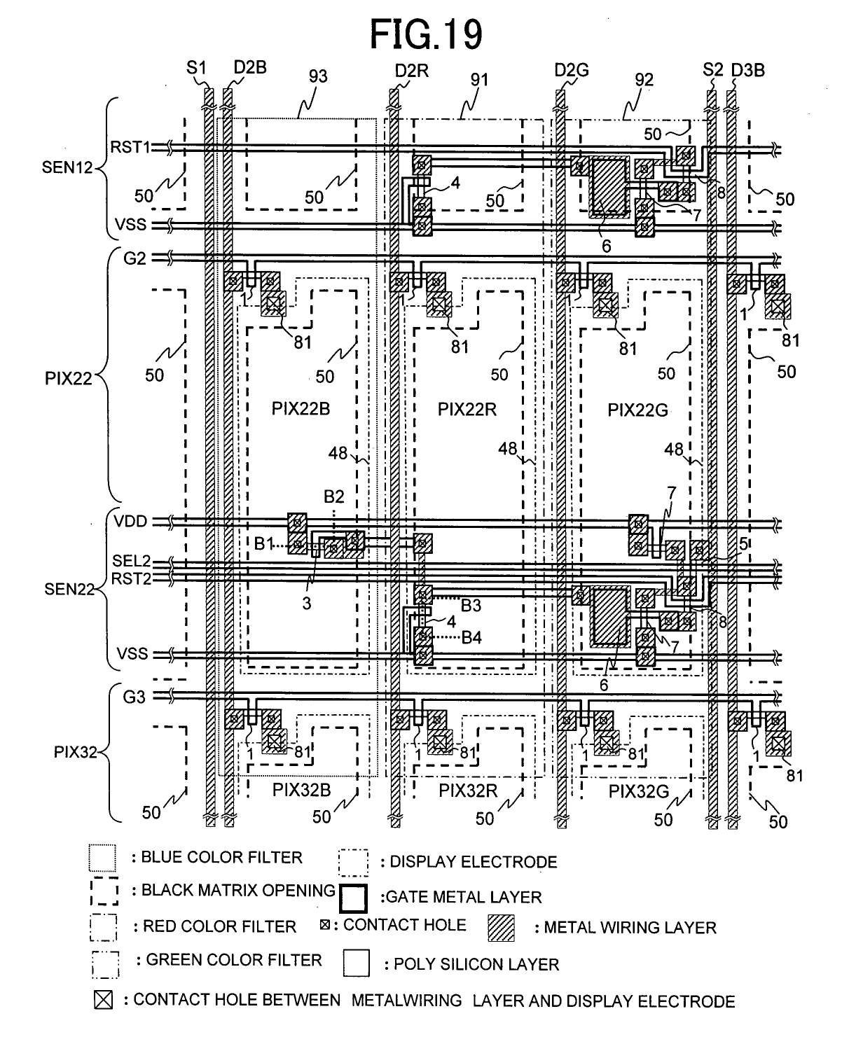

FIG. 19 shows a layout example of the display pixel circuit PIX and the photo-sensing circuit SEN of the present embodiment. The display pixel circuits PIX 22B and PIX 32B as well as the photo-sensing TFT 3 of the photo-sensing circuits SEN 12 and SEN 22 are arranged beneath the blue color filter 93, the display pixel circuits PIX 22R and PIX 32R as well as the photo-sensing TFT 4 of the photo-sensing circuits SEN 12 and SEN 22 are arranged beneath the red color filter 91, and the display pixel circuits PIX 22G and PIX 32G as well as the capacitor 6, the reset TFT 8, read TFT 5 and the inverter amplifier 7 of the photo-sensing circuits SEN 12 and SEN 22 are arranged beneath the green filter 92.

Then, the red color filter 91, the green color filter 92 and the blue color filter 93 are formed in a stripe pattern at a black matrix opening portion 50, the areas other than those filters are covered with the black matrix 24, and wiring (S1, S2, D2B, D2R, D3B), the display pixel TFT 1, etc. shield light such as sunlight that are illuminated on the screen.

The source and the drain of each TFT are formed with the polysilicon layer 49. Further, respective wiring of voltage VDD, VSS, RST 1, RST 2, SEL 1, SEL 2, the gate lines G2 and G3 as well as gate electrode of respective transistors are formed with the gate metal layer 43. Furthermore, the data lines D2R, D2G, D2B and D3B as well as the photo-sensing circuit output lines S1 and S2 and remaining wiring are formed with the metal wiring layer 45.

The display electrode 48 is formed in a way to overlap most portions of components of the display pixel circuit PIX and the photo-sensing circuit SEN and is connected to the metal wiring layer 45 via the contact hole 81.

The two TFTs 7 including the photo-sensing TFT 3, the photo-sensing TFT 4, the read TFT 5, the reset TFT 8 and the inverter amplifier 7 are formed by overlapping wiring of the gate metal layer 43 and wiring of the polysilicon layer 49.

Further, the capacitor 6 is formed with the gate metal layer 43 and the metal wiring layer 45, wherein the metal wiring layer 45 is connected to the polysilicon layer 49 of the photo-sensing TFT 4 via the contact hole 46.

Here, B1-B2 shown in FIG. 19 is the portion corresponding to B1-B2 including the photo-sensing TFT 3 shown in the cross section diagram in FIG. 15, and B3-B4 is the portion corresponding to B3-B4 including the photo-sensing TFT 3 shown in the cross section diagram in FIG. 15.

Configuration and operations of the image display device of the present embodiment are the same as those of the sensor circuit 13 shown in FIG. 13 of the first embodiment. The signal lines S1 and S2 shown in FIG. 18 are respectively connected to the terminals S1 and S2 of the sensor circuit 13. The image display device includes terminal switches SW 1 and SW 2 which control the selection switch 74 and the selection switch 75, a terminal for reference voltage Vref to be input to the sample hold circuit 71, and a terminal Vsig which is connected to the output terminal from the latch circuit 73.

When the signal voltage S1 or S2 is input to the sample hold circuit 71, sampling is performed and sampling data is stored during a prescribed time period. During the period, the amplifier 72 amplifies difference ΔV between the sampling data and the judgment reference voltage Vref and delivers the difference to the latch circuit 73. The latch circuit 73, based on the signal delivered from the amplifier circuit 72, finally outputs a binary digital judgment signal Vsig.

An effect of the image display device of the present embodiment is that the sensor circuit PS of the embodiment acts in a way similar to the photo-sensing circuit PS of the first embodiment shown in FIG. 4, by arranging the photo-sensing TFT 3 beneath the blue filter 93 which disperses light into the wavelength λB or its vicinity at which light transmittance reaches the peak, and the photo-sensing TFT 4 beneath the red filter 91 which disperses light into the wavelength λR or its vicinity at which light transmittance reaches the peak.

Further, since the photo-sensing TFT 4 functions as a shielding TFT because light to be illuminated on the screen can be shielded by the red filter 91, there is no need to expand the area of the black matrix 24 for the purpose of providing a shield for the photo-sensing TFT 4.

Likewise, concerning the capacitor 6, the inverter amplifier 7, the reset TFT 8 and the read TFT 5 which are circuit elements that should be free from influence of light to be illuminated on the screen, since they become free of influence by light (disturbance light) to be illuminated on the screen by arranging them beneath the red filter 91 or the green filter 92, there is no problem of malfunction, deterioration, etc. that could be caused by illumination of disturbance light. In the case where a circuit element or a light sensor is incorporated in the display unit, there is no need to change shape of the RGB color filters that are formed for display purpose.

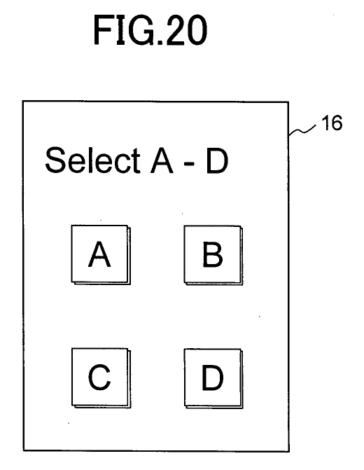

FIG. 20 shows the status that a prescribed image is displayed on the display unit 16, wherein switch-shaped displays marked with “A”, “B”, “C” and “D” are shown along with the letters “Select A-D.” This shows the status waiting for selective inputting by a user to touch the switch “A”, “B”, “C” or “D.” Whether the user touched the switch-shaped display area marked with “A”, “B”, “C” or “D” on the screen is judged by transmitting the output signal voltage of the photo-sensing circuit SEN formed within the display unit 16 to the sensor circuit 13 and by using binary judgment signal Vsig.

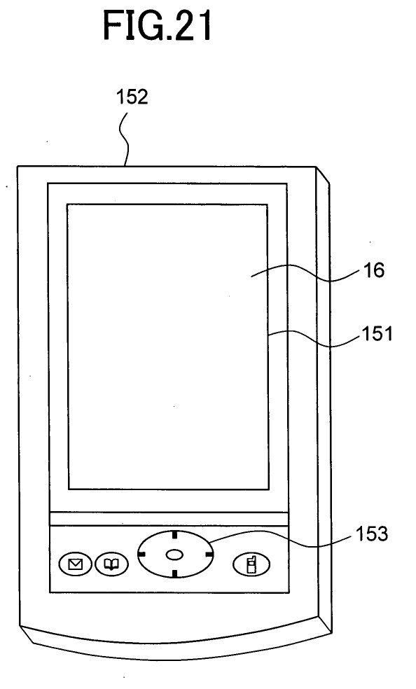

FIG. 21 shows a mobile electronic apparatus to which the image display device of the present embodiment or the first embodiment is applied. A mobile electronic apparatus 152 is provided with an arrow key 153 in addition to the display unit 16 of the image display device of the present embodiment or the first embodiment. By applying an image display device 151 according to the present invention enables a user interface having touch-panel functions to be selectively processed by touching displays such as an icon on a display screen of the image display device 151 with the finger 51 or a stylus pen. Moreover, no dedicated touch panel module is required.

It should be noted that, in the present embodiment, arrangement of color filters are described by taking a stripe-pattern arrangement as an example. However, the stripe-pattern arrangement is not always necessary, and it is obvious that a triangle arrangement, a mosaic arrangement, etc. may be applied.

### Third Embodiment

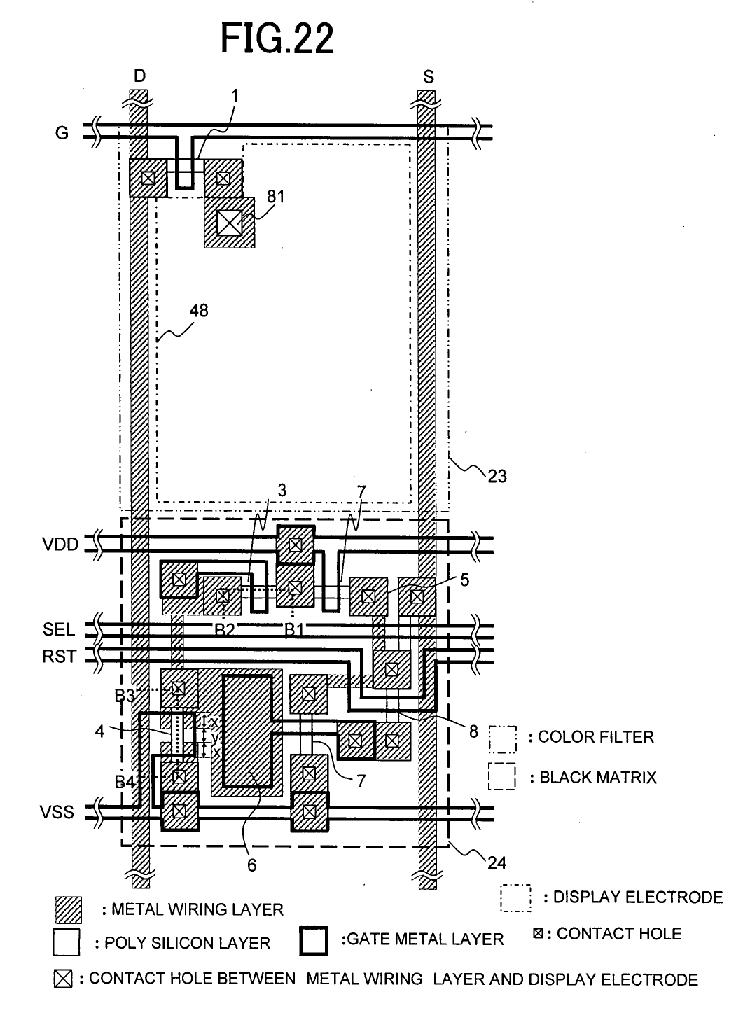

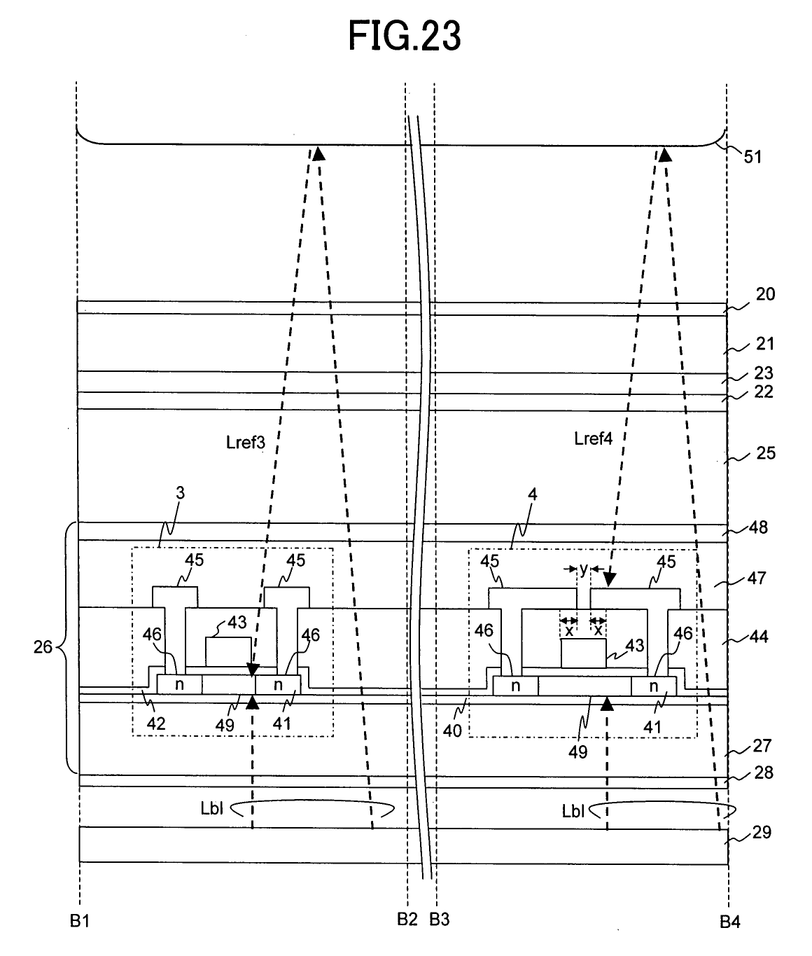

Hereinafter, a third embodiment of the present invention will be described with reference to FIGS. 22 and 23.

FIG. 22 shows a layout example of the display pixel circuit PIX and the photo-sensing circuit SEN of the third embodiment. The configuration of the layout example of the display pixel circuit PIX and the photo-sensing circuit SEN of the third embodiment is basically same as that of the first embodiment.

A different point from the first embodiment is that the metal wiring connected to the drain and the source electrodes on the gate electrode of the photo-sensing TFT 4 is extended by the distance x and the channel layer 49 is extended by the distance y from those in FIG. 12 to form an overlapping area and shield external light, thus preventing external light from being incident on the channel layer 49 of the external photo-sensing TFT 4. Here, the distance x is an overlapping spacing of the gage metal layer 43 and the metal wiring layer 45, the distance y is wiring spacing of the metal wiring layer 45. The distances should be sufficient so far as they ensure overlapping status so that the channel layer 49 can be shielded from external light. For example, the distance x may be around 4 μm, and the distance y may be around 4 μm when manufacturing processes are considered.

FIG. 23 shows a cross-section structure of the image display device according to the third embodiment of the present invention.

The cross-section structure of the image display device according to the third embodiment is basically similar to that of the first embodiment shown in FIG. 2. A different point from the first embodiment is that, since the two metal wiring layers 45 connected to the drain and the source electrodes extend by the distance x respectively to secure larger wiring spacing than the distance y. Consequently, since the length of the channel layer 49 of the photo-sensing TFT 4 is made larger, the area of the photo-sensing TFT 4 is larger than that of the first embodiment shown in FIG. 2.

The white light Lb1 emitted from the backlight 29 penetrates the lower deflector plate 28 and the glass substrate 27 and is illuminated to the lower sides of the channel layers 49 of the photo-sensing TFT 3 and the photo-sensing TFT 4.

On the other hand, the light Lb1 from the backlight 29 penetrates the lower deflector plate 28, the glass substrate 27, the TFT substrate 26, the liquid crystal element 25, the counter electrode 22, the color filter 23, the color filter side glass substrate 21 and the color filter side deflector plate 20. The touch-reflected light Lref reflected on the finger 51 which touched the screen is reflected again toward the TFT substrate 26, penetrates the color filter side deflector plate 20, the color filter side glass substrate 21, the color filter 23, the counter electrode 22 and the liquid crystal element 25, and is incident on the TFT substrate 26. The light Lref 3 which is reflected toward the photo-sensing TFT 3 is reflected between the gate electrode 43 and the gate insulation film 42 of the photo-sensing TFT 3 and is incident on the channel layer 49. The light Lref 4 which is reflected to the side of the photo-sensing TFT 4 is shielded by the metal layer 45 that is place to cover the photo-sensing TFT 4 and is not incident on the channel layer 49 of the photo-sensing TFT 4.

Therefore, as is the case with the first embodiment, the light to be illuminated on the photo-sensing TFT 3 includes the backlight light Lb1 to be incident from the lower side of the photo-sensing TFT 3 and the touch-reflected light Lref 3 to be incident from the upper side of the photo-sensing TFT 3. The light to be illuminated on the photo-sensing TFT 4 is the backlight light Lb1 to be incident from the lower side of the photo-sensing TFT 4.

According to the embodiment, there is no need to form a black matrix on the photo-sensing circuit SEN unlike the first embodiment. Further, the photo-sensing circuit SEN can be arranged irrespective of the arrangement of color filters as is the case with the second embodiment. For this reason, comparing to the first and the second embodiments, arrangement of the selection switches is not limited, which would result in improvement in integration degree of the photo-sensing circuit SEN.

### Fourth Embodiment

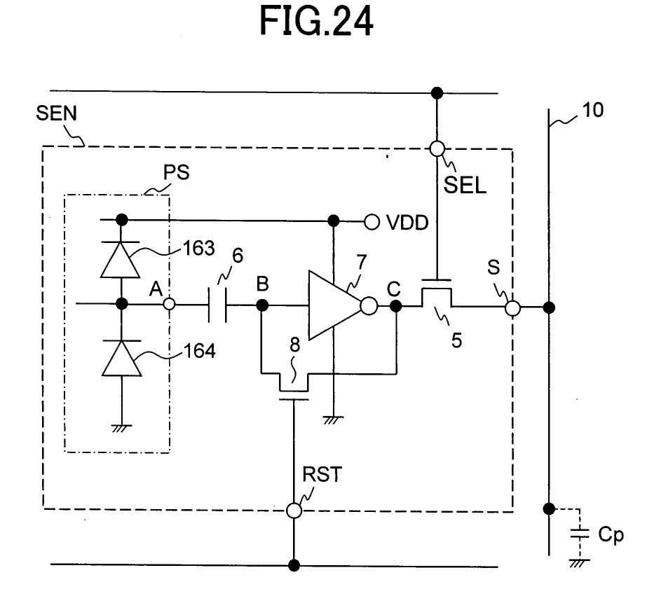

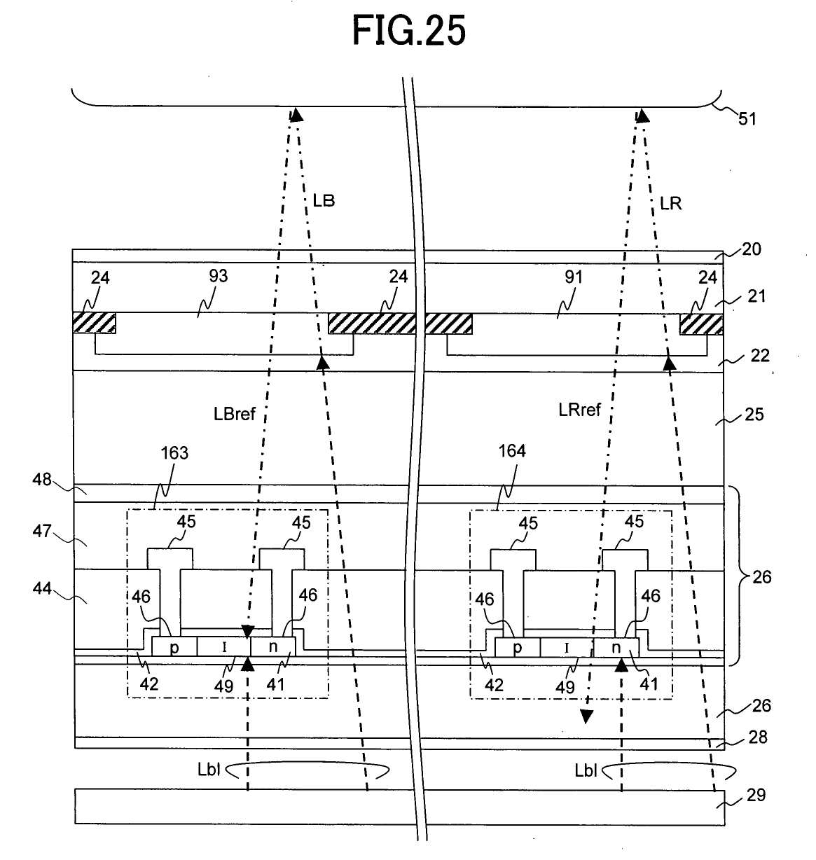

Hereinafter, a fourth embodiment of the present invention will be described with reference to FIGS. 24 and 25.

FIG. 24 shows a circuit configuration diagram of a photo-sensing circuit PS of the fourth embodiment. Configuration and operations of the image display device of the present embodiment is basically similar to those of the first embodiment.

A different point from the first embodiment is that the photo-sensing TFT 3 and the photo-sensing TFT 4 in the photo-sensing circuit PS are replaced with a photodiode 163 and a photodiode 164 respectively. Thus, only the photodiodes will be described hereinafter.

With the photodiode used in the fourth embodiment, a light signal current is generated according to light absorption amount in the channel layer when light is incident as is the case with the photo-sensing TFT used in the first embodiment, the photodiode provides operations similar to those of the photo-sensing circuit PS of the first embodiment shown in FIG. 4 and provides similar effect.

FIG. 25 shows a cross-section structure of an image display device of the fourth embodiment.

A counter deflector plate 20, a color filter side glass substrate 21, a color filter 23, a black matrix 24, a counter electrode 22, a liquid crystal element 25, a glass substrate 27, a lower deflector plate 28 and a backlight 29 are configured in a similar way to those of the first embodiment. The illumination direction of light toward the image display device is similar to that of the first embodiment shown in FIG. 2.

Hereinafter, the structure of the light sensor unit 26 will be described.

An insulation film 40 made of oxide silicon is formed on the glass substrate 27. A polysilicon layer 41 is formed on the insulation film 40. P-type and n-type channel layers 49 are formed in the photo-sensing TFT 3 and the photo-sensing TFT 4 by doping p-type and n-type impurities in the polysilicon layer 41, on which a gate metal layer 43 is formed with a gate insulation film 42 sandwiched in between the channel layer 49 and the gate metal layer 43. Further, on the gate metal layer -43, a metal wiring layer 45 is formed with an interlayer insulation film 44 made of oxide silicon sandwiched in between the gate metal layer 43 and the metal wiring layer 45. The metal wiring layer 45 extends through the gate insulation film 42 and the interlayer insulation film 44 by way of a contact hole 46 and is connected to the polysilicon layer 41 in which n-type impurities are doped, thus forming an electrode. Further, on the metal layer 45, a display electrode 48 is formed with a planarizing insulation film 47 sandwiched in between the metal layer 45 and the display electrode 48. It should be noted that, in FIG. 25, a layer I which will be channel layers of the TFTs 163 and 164 is a non-doped polysilicon layer.

According to the present embodiment, since gate electrodes of the photo-sensing TFTs 162 and 164 shown in FIG. 25 are not required, light focusing factor of light reflected on a finger that touched the screen becomes higher than that of the photo-sensing TFTs 3 and 4 of the first embodiment shown in FIG. 2, and a photo-sensing circuit PS having high S/N ratio can be realized. Therefore, it is also possible to reduce the sizes of the photo-sensing TFTs 162 and 164.

In the present embodiment, a liquid crystal image display device described in the first embodiment is used as an image display device. However, it is obviously possible to use display panels of other structures than the liquid crystal image display device, including an organic electroluminescence (EL) display that can satisfy the subject matter of the present invention.

It should be noted that, in the first to the fourth embodiments of the present invention, TFTs are formed by using polysilicon thin films. However, other organic/inorganic semiconductor thin films may also be used for transistor, without limiting to polysilicon.

1. An image display device comprising:
a display unit in which a plurality of display pixels are arranged in a matrix;
a plurality of display signal lines which are used to write a display signal in the display pixels;
a plurality of light detection pixels which detect a light input and which are arranged in the display unit in a matrix;
a signal reading unit which, upon receiving a detection signal from the light detection pixels, executes a prescribed signal processing;
a light detection pixel selection circuit for reading the signal that has been processed in the signal reading unit;
the light detection pixels having:
a light sensor unit including a first light detection element that receives observation light and a second light detection element that does not receive observation light;
the signal reading unit which, upon receiving a first detection signal that is generated by the first light detection element and a second detection signal that is generated by the second light detection element, executes a prescribed signal processing; and
a light detection pixel selection circuit for reading the signal that has been processed in the signal reading unit;
wherein, the processed signal is output from the plurality of light detection pixels that are selected by the light detection pixel selection circuit.

2. The image display device according to claim 1,
wherein the signal reading unit amplifies a difference between the first detection signal that is generated by the first light detection element and the second detection signal that is generated by the second light detection element.

3. The image display device according to claim 1, further comprising a plurality of reading selection lines,
wherein the light detection pixel selection circuit includes a reading selection switch and an output signal line; and
the plurality of light detection pixels to be read to the output signal line are selected when an end of the reading selection switch is connected to the signal reading unit, the other end of the reading selection switch is connected to the output signal line, and the reading selection line and the reading selection switch are connected with each other.

4. The image display device according to claim 3,
wherein the light detection pixels are selectively read to the output signal line from the signal reading unit when the reading selection switch is turned on in a prescribed period via the reading selection line.

5. The image display device according to claim 1,
wherein the light detection pixels are made up with the first light detection element and the second light detection element that are electrically connected each other; and
processed signal to which a prescribed signal processing is applied, upon receiving a voltage at a connection node of the first light detection element and the second light detection element, is output from the signal reading unit.

6. The image display device according to claim 5,
wherein the signal reading unit includes an amplifier circuit; and
the processed signal is amplified in the amplifier circuit.

7. The image display device according to claim 5,
wherein the signal reading unit includes a capacitor, an amplifier circuit and a reset switch which short-circuits the input and the output terminals of the amplifier circuit;
the light detection unit and the capacitor are connected; the capacitor and the input terminal of the amplifier circuit and the a terminal of the reset switch are connected; and the output terminal of the amplifier circuit and the other terminal of the reset switch are connected.

8. The image display device according to claim 5,
wherein the light detection pixel selection circuit includes a reading selection switch, a plurality of reading selection lines and an output signal line;
a terminal of the reading selection switch is connected to the signal reading unit;
the other terminal of the reading selection switch is connected to the output signal line;
the plurality of reading selection lines are connected to the reading selection switch; and
a plurality of the light detection pixels to be read to the output signal line are selected via the plurality of reading selection lines.

9. The image display device according to claim 8,
wherein an output of the reading unit is selectively read to the output signal line when the reading selection switch is turned on in a prescribed period via the reading selection line.

10-15. (canceled)

16. The image display device according to claim 1, further comprising a metal wiring layer,
wherein the metal wiring layer of the second light detection element is placed in a manner to overlap the second light detection element.

17. The image display device according to claim 1, further comprising:
a sensor output unit that includes a plurality of light detection elements, a plurality of output signal lines, a plurality of line selection switches and a comparator circuit;
a line selection signal line; and
a reference voltage terminal,
wherein the sensor output unit and the plurality of output signal lines are connected; each of the plurality of output signal lines is connected with each of ends of a plurality of line selection switches; each of the other ends of the plurality of line selection switches is connected with an input terminal of the comparator circuit; and the reference voltage terminal is connected with the other input terminal of the comparator circuit.

18. The image display device according to claim 17,
wherein a series of processes are repeatedly executed for the number of times that are equivalent to the number of the plurality of output signal lines, the processes comprising the steps of:
transmitting an output signal of the light detection element to the sensor output unit through a plurality of the output signal lines;
turning on one of the plurality of line selection switches via the line selection signal lines in a prescribed time period;
causing the line selection switch to be conductive;
selecting one of the plurality of output signal lines;
inputting the output signal that is transmitted to the selected output signal line;
comparing the output signal and a prescribed reference voltage; and
outputting a binary logic signal based on the comparison result.

19. The image display device according to claim 1,
wherein the display pixels are of liquid crystal pixels.

20. The image display device according to claim 1,
wherein the display pixels are of EL display pixels.

21. The image display device according to claim 1,
wherein the display pixels are of organic EL light emitting diodes.

22. The image display device according to claim 1,
wherein the light detection elements are of thin-film diodes.

23. The image display device according to claim 1,
wherein the light detection elements are of thin-film transistors.

24. The image display device according to claim 23,
wherein the light detection elements are of thin-film transistors that are diode-connected.

25. The image display device according to claim 23, further comprising a power supply wiring line,
wherein the light detection elements and the power wiring line are connected; and a variable voltage is applied to the power wiring line.

26. The image display device according to claim 1,
wherein all elements that form the display pixels and the light detection pixels are configured with n-channel TFTs.

27. The image display device according to claim 1,
wherein a plurality of elements that form the display pixels and the light detection pixels are configured by n-channel TFTs, or p-channel TFTs, or a plurality of n-channel TFTs and p-channel TFTs.

28-30. (canceled)

31. An image display device comprises:
a display unit in which a plurality of display pixels are arranged in a matrix;
a plurality of display signal lines which are used to write a display signal in the display pixels;
a light detection units having a plurality of light detection pixels which detect a light input and which are arranged in the display unit;
a light shielding unit which shields light input and which is arranged in the display unit;
a signal reading unit which, upon receiving a detection signal from the light detection unit, executes prescribed signal processing; and
a light detection pixel selection circuit for reading the signal which has been processed in the signal reading unit;
wherein a plurality of light detection pixels of the light detection unit each include a first light detection element which receives observation light and a second light detection element which receives observation light via the light-shielding unit;
the signal reading unit, upon receiving the first detection signal that is generated by the first light detection element and the second detection signal that is generated by the second light detection element, executes the prescribed signal processing; and
the processed signal is output from the plurality of light detection elements that are selected by the light detection pixel selection circuit.
